(19) United States
(12) Patent Application Publication
(10) Pub. No.: US 2026/0117636 A1
(43) Pub. Date: Apr. 30, 2026

(54) HYDRAULIC FRACTURING HOSE HANDLING ASSEMBLY AND METHODS OF USE

(71) Applicant: Scout Surface Solutions LLC, Joshua, TX (US)

(72) Inventors: Lawrence Ray McHorse, Joshua, TX (US); Thomas G. Roesner, Joshua, TX (US); John A. Chappell, Joshua, TX (US); David Lane Evans, Joshua, TX (US)

(21) Appl. No.: 19/369,615

(22) Filed: Oct. 27, 2025

Related U.S. Application Data
(60) Provisional application No. 63/713,879, filed on Oct. 30, 2024.
(60) Provisional application No. 63/717,584, filed on Nov. 7, 2024.

(51) Int. Cl. E21B 43/26; F16L 3/20

(52) U.S. Cl. CPC E21B 43/2607; F16L 3/20

(57) ABSTRACT

A fluid conduit assembly and methods for a fluid supply system for a hydraulic fracturing system may include a manifold assembly coupled to a series of pumping units by hoses along which a hydraulic fluid is conveyed from the pumps of the pumping units to the manifold assembly. The hoses are supported by a plurality of hose handling assemblies. The hose handling assemblies each include a body with a hose cradle pivotally coupled thereto and in which hose is received. The hose handling assemblies are configured to facilitate movement of the hoses in multiple directions for positioning of the hoses.

### CROSS REFERENCE TO RELATED APPLICATIONS

This application claims priority to and the benefit of U.S. Provisional Application No. 63/713,879, filed Oct. 30, 2024, titled “HYDRAULIC FRACTURING HOSE HANDLING ASSEMBLY AND METHODS OF USE,” and U.S. Provisional Application No. 63/717,584, filed Nov. 7, 2024, titled “HYDRAULIC FRACTURING HOSE HANDLING ASSEMBLY AND METHODS OF USE,” the disclosures of which are incorporated herein by reference in their entireties.

### TECHNICAL FIELD

The present disclosure relates generally to hydraulic fracturing systems and methods, and in particular, to systems and methods for handling hoses or conduits connecting one or more pumping systems to one or more wellbores for performing hydraulic fracturing operations.

### BACKGROUND

Hydraulic fracturing operations are used for extracting fluids such as hydrocarbon gases, oil, etc. from subterranean formations. During a hydraulic fracturing operation, a pressurized fracturing fluid is injected into the subterranean formation via one or more wellbores at a higher pressure than a fracture pressure of the subterranean formation. The pressurized fluid creates fractures that increase a permeability of the subterranean formation so that fluids such as oil, gas, water, etc. may be more easily extracted to the surface via the wellbore(s). Various types of pumping systems generally will be used to pump the fracturing fluids under pressure into and out of the wellbore(s) during hydraulic fracturing operations. The pumps will be connected to the wellbore(s) by fluid conveyance devices, which may include various combinations of pipes, hoses, conduits, manifolds, tanks, pumps, etc. Generally, flexible hoses are used to connect the pumps to a manifold that will distribute the fluids to the wellbores and return extracted fluids. Such hoses must be configured to withstand relatively high differential fluid pressures during fracturing operations, and typically are difficult to manipulate and reposition due to their size and weight, particularly when pressurized fracturing fluids are being pumped therethrough, and given the limited space for placement of the hoses between the pumping systems and manifolds of hydraulic fracturing systems. As a result, the hoses typically will be run along the surface of the ground at the fracturing site between the pumps and the manifold(s) where they can be exposed to corrosive materials, dirt, mud, and other contaminants, as well as being extended along an uneven flow path with bends and/or sagging of the hoses, which can restrict the flow of the pressurized fluids therethrough.

Accordingly, it can be seen that a need exists for systems, assemblies, and components thereof, which can enable the handling and manipulation of hydraulic fracturing hoses at a site of a hydraulic fracturing operation, and methods of use thereof, which are configured to address the foregoing and other related and unrelated problems in the art.

### SUMMARY

A summary of various aspects and embodiments of hydraulic fracturing hose handling assemblies, components, and methods of use thereof, as disclosed herein, is set forth below. It should be understood that the present summary is presented merely to provide a brief discussion of example aspects and embodiments of the hydraulic fracturing hose handling assemblies, components, and methods of use thereof, and is not intended to limit the scope of the present disclosure. Indeed, the present disclosure may encompass a variety of aspects and embodiments of the hydraulic fracturing hose handling assemblies and components and methods of use thereof according to the principles of the present disclosure that may not be set forth below.

According to some aspects, a system for supplying hydraulic fracturing fluids for hydraulic fracturing operations can comprise: one or more pumping units coupled to a fluid supply and configured to pump the fracturing fluid from the fluid supply to a fluid delivery conduit of a manifold assembly; one or more fluid inlet located along the fluid delivery conduit and configured to receive the fracturing fluid from the one or more pumping units and direct the fracturing fluid into the fluid delivery conduit; one or more hose coupled to the one or more pumping units at a first end and to the one or more fluid inlet at a second end, the one or more hose configured to deliver the fracturing fluid from the one or more pumping units along a flow path to the one or more fluid inlet; and a hose handling assembly adapted to be positioned along a length of the one or more hose and configured to support the one or more hose and selectively move the one or more hose in a plurality of directions.

In embodiments of the system, the hose handling assembly is configured to facilitate a turning movement of the one or more hose, a pivoting movement of the one or more hose, and movement of the one or more hose in a substantially vertical direction, in a substantially horizontal direction.

In embodiments of the system, the hose handling assembly can comprise a body including a base supported on a ground surface; a hose cradle having a channel defined therethrough and along which the one or more hose is received; a cradle support having a first end connected to the base and a second end connected to the hose cradle; and one or more mechanisms attached to the hose cradle, to the base, or to the cradle support, and configured to move the hose cradle, the base, or the cradle support in a substantially vertical direction for moving the one or more hose between one or more lowered position and one or more elevated positions.

In embodiments of the system, the body of the hose handling assembly further comprises a rotatable connector positioned between the hose cradle and the cradle support and configured to enable turning of the one or more hose. In some embodiments, the rotatable connector can further be configured to enable pivoting of the hose cradle about a pivot adjacent an upper end of the hose cradle. In other embodiments, the body further can include a pivoting connector coupled to the hose cradle and to the rotatable connector and configured to enable pivoting of the hose.

In embodiments of the system, the hose handling assembly further comprises an injector drive mechanism.

In embodiments of the system, the injector drive mechanism can comprise one or more drive wheels positioned along the channel defined through the hose cradle; and one or more drive motor coupled to the one or more drive wheels. For example, one or more drive wheels can be located along the channel in a position to engage the hose received therein, and the one or more motor can be configured to drive rotation of the one or more drive wheels; wherein the hose is engaged by the one or more drive wheels; and wherein the one or more drive motor is configured to be selectively operable to drive rotation of the one or more drive wheels for moving the one or more hose in a horizontal direction.

In some embodiments of the system, the injector drive mechanism can comprise one or more belts or tracks moveable in forward and reverse directions wheels for moving the one or more hose in a horizontal direction. In embodiments, the one or more belts or tracks can be extended about two or more gears or sheaves and can be driven by one or more motor; while in other embodiments, the one or more belts or tracks can be manually driven. In embodiments two or more belts or tracks can be arranged side-by-side, or opposite one another.

In additional embodiments of the system, the injector drive mechanism can comprise a pair of belts or tracks positioned along opposite sides of a channel defined through the hose cradle; wherein the belts or tracks will engage the body of a hose received within the channel; and wherein as the belts or tracks are driven in the forward and reverse directions, the hose is caused to move in a substantially horizontal direction.

In other embodiments of the system, the hose handling assembly can include a body having a base, a cradle support, and a hose cradle rotatably connected to an upper end of the cradle support; wherein the hose cradle is rotatable with respect to the cradle support to enable the one or more hose to be turned about a substantially vertically extending axis. In some further embodiments of the system, the hose cradle can be pivotally coupled to the cradle support to enable the one or more hose to be pivoted with respect to the cradle support to reorient the flow path defined through the one or more hose.

In embodiments of the system, the one or more lifting mechanisms can comprise an actuator coupled to a lifting rod positioned between the actuator and the hose cradle wherein the actuator is operable to selectively extend or retract the lifting rod and move the hose cradle in the vertical direction to move the one or more hose between its one or more lowered position and one or more elevated positions.

In some embodiments of the system, the one or more lifting mechanisms can comprise a manually operable jack mechanism.

In other embodiments of the system the one or more lifting mechanisms can include a lifting rod and an actuator; and wherein the actuator of the one or more lifting mechanisms can comprise a pneumatic or hydraulic cylinder, or a motor.

In some embodiments of the system, the hose handling assembly can comprise a body including a hose cradle having a channel defined therethrough and along which the one or more hose is received and a injector drive mechanism positioned along the channel and operable to move the one or more hose in a horizontal direction; and wherein the hose cradle is rotatable about a substantially vertically extending axis to enable the one or more hose to be turned.

In embodiments of the system, the body of the hose handling assembly can further include a cradle support rotatably coupled to the hose cradle; and wherein the one or more lifting assembly can be linked to the cradle support and will be configured to move the hose cradle with the one or more hose supported therein in a vertical direction.

In some embodiments of the system, the body of the hose handling assembly can include a cradle support rotatably and pivotally coupled to the hose cradle to enable turning of the hose about a substantially vertical axis, pivoting for the hose with respect to a surface of the ground; and wherein the one or more lifting assembly can be linked to the cradle support and will be configured to move the hose cradle with the one or more hose supported therein in a vertical direction.

In additional embodiments of the system, the body further includes a base, and the one or more lifting assembly comprises a plurality of jack mechanisms connected to the base.

In some embodiments of the system, the manifold can comprise a monobore manifold.

In further embodiments of the system, the hose handling assembly can comprise a body including a hose cradle rotatably coupled to the body, the hose cradle configured to receive the one or more hose therethrough; an injector drive mechanism configured to move the one or more hose through the hose cradle in a substantially horizontal direction; and one or more lifting assembly mounted along the body and configured to cause movement of the one or more hose in a substantially vertical direction for positioning the one or more hose at a selected elevation above a ground surface; and wherein the hose cradle is pivotally and rotatably coupled to the body to enable turning of the one or more hose about a vertical axis and pivoting of the one or more hose with respect to the body.

According to another aspect, a hose handling assembly comprises a body including a base configured to stand and be supported on a ground surface; a cradle support mounted to an upper portion of the base; a hose cradle rotatably coupled to the cradle support to enable rotational movement of the one or more hose about a vertical axis, and having a channel defined therethrough and along which the one or more hose is received; an injector drive mechanism coupled to the hose cradle and configured to move the one or more hose in a substantially horizonal direction of movement; and one or more lifting mechanisms attached to the hose cradle, to the base, or to the cradle support, and configured to move the one or more of hose cradle, the base, and the cradle support for moving the one or more hose in a substantially vertical direction of movement. In addition, in embodiments, the hose cradle can be pivotally coupled to the cradle support to enable pivoting of the one or more hose.

According to other aspects, a hose handling assembly is provided, and comprises a body including a cradle support; a hose cradle coupled to the cradle support and having a cradle body configured to receive a hose therethrough; an injector drive mechanism configured to move the hose through the hose cradle in a substantially horizontal direction; and one or more lifting assembly mounted along the body and configured to move the hose in a vertical direction; and wherein the hose cradle is rotatably and pivotally coupled to the cradle support so as to facilitate a turning movement of the hose, and a pivoting movement of the one or more hose, and movement of the one or more hose in a substantially vertical direction, in a substantially horizontal direction

In embodiments, the body further can comprise a rotatable connector positioned between the hose cradle and the cradle support and configured to enable a turning movement of the hose about the vertical axis. In some embodiments, the rotatable connector can be configured to enable the hose to be pivoted about a pivot point located adjacent an upper end of the cradle support.

In embodiments, the body can comprise a base adapted to engage a ground surface, and a cradle support having a first end mounted to the base and a second end rotatably coupled to the hose cradle.

In some embodiments, the one or more lifting mechanisms comprises a plurality of jack mechanisms connected to the base. In addition, in embodiments, the one or more lifting mechanisms is positioned along the cradle support at the second end thereof and includes a lifting rod having a rotatable connector at a distal end thereof and connected to the hose cradle.

In embodiments, the injector drive mechanism can comprise one or more drive wheels positioned along a channel defined through the body of the hose cradle so as to engage a portion of the hose, and one or more drive motor coupled to the one or more drive wheels; and wherein the one or more drive motor is configured to selectively drive rotation of the one or more drive wheels so as to move the hose in the substantially horizontal direction.

In embodiments, the body can further comprise a rotatable connector configured to connect the hose cradle to the cradle support such that the hose cradle is rotatable about a substantially vertical axis to turn the hose so as to realign the hose as needed. In some embodiments, the rotatable connector can be configured to enable the hose to be pivoted about a pivot point located adjacent an upper end of the cradle support.

In embodiments, the body further comprises a base along which the cradle support is mounted; wherein the one or more lifting mechanisms comprises a plurality of jack mechanisms mounted to the base, each jack mechanism including a lifting rod connected to an actuator; and wherein the actuators of the jack mechanisms are operable to selectively extend or retract the lifting rods to move the body in a substantially vertical direction for moving the one or more hose between a lowered position and one or more elevated positions.

In embodiments, the injector drive mechanism comprises a support spaced from the body and having a frame, one or more belts or tracks supported along the frame, and a drive configured to drive movement of the one or more belts or tracks for moving the hose in the substantially horizontal direction.

According to other aspects, a fluid delivery system for a hydraulic fracturing operation is provided, comprising: one or more pumping units coupled to a fluid supply and configured to pump a pressurized fluid from the fluid supply to a fluid delivery conduit of a manifold assembly; one or more hose coupled to the one or more pumping units at a first end and to an inlet of the fluid delivery conduit at a second end, the at least one hose configured to deliver the pressurized fluid from the one or more pumping units along a flow path to the inlet; one or more hose handling assembly positionable between one or more pumping units and the fluid delivery conduit; and wherein the one or more hose handling assembly is configured to support the one or more hose in an elevated position and to facilitate movement of the one or more hose in multiple directions.

In embodiments, the hose handling assembly is configured to facilitate a turning movement of the one or more hose, a pivoting movement of the one or more hose, movement of the one or more hose in a substantially vertical direction, movement of the one or more hose in a substantially horizontal direction.

In embodiments, the hose handling assembly comprises a hose cradle configured to receive the one or more hose therethrough and including an injector drive mechanism operable to move the one or more hose in a substantially horizontal direction; and wherein the hose cradle is rotatable about a vertical axis to enable turning of the one or more hose.

In embodiments, the hose handling assembly further comprises a body including a cradle support, a hose cradle rotatably coupled to the cradle support, and one or more lifting mechanisms positioned along the body and configured to move the cradle support or the hose cradle with the one or more hose supported therein in a substantially vertical direction.

In embodiments, the body comprises a base adapted to engage a ground surface, and a cradle support mounted to the base at a first end and rotatably coupled to the cradle support adjacent a second end thereof.

In embodiments, the one or more lifting mechanisms comprises a plurality of jack mechanisms connected to the base of the body.

In embodiments, the one or more lifting mechanisms is positioned along the cradle support at the second end thereof and includes a lifting rod having a rotatable connector at a distal end thereof and connected to the hose cradle.

In embodiments, the system can further comprise a pivoting connector positioned at an upper end of the lifting rod of the one or more lifting mechanisms and pivotally coupled to the hose cradle; wherein the pivoting connector is configured to enable pivoting of the one or more hose and turning of the one or more hose with respect to the cradle support.

In embodiments, the one or more hose handling assembly comprises: a body including a base, a cradle support, and a hose cradle coupled to the cradle support and comprising a cradle body configured to receive the one or more hose therethrough; and one or more lifting assembly mounted along the body and configured to move the base, the cradle support, or the hose cradle in a substantially vertical direction to raise the one or more hose to an elevated position; wherein the hose cradle is rotatably coupled to the cradle support so as to facilitate turning of the one or more hose about a substantially vertically extending axis; and wherein the hose cradle is pivotally coupled to the cradle support to facilitate pivoting of the one or more hose.

In embodiments, the system can further comprise an injector drive mechanism linked to the cradle body and configured to move the one or more hose through the hose cradle in a substantially horizontal direction.

In some embodiments, the injector drive mechanism comprises one or more drive wheels positioned along a channel defined through the hose cradle and adapted to engage the one or more hose, and one or more motor coupled to the one or more drive wheels; and wherein the one or more motor is configured to selectively drive rotation of the one or more drive wheels for moving the one or more hose in the substantially horizontal direction.

In some embodiments, the injector drive mechanism is positioned at a location spaced from the body, and comprises a pair of drive belts defining a passage along which the hose is received, and one or more actuator connected to the drive belts and configured to drive the drive belts in forward and reverse directions for moving the hose in the substantially horizontal direction.

In embodiments, the one or more lifting mechanisms comprises an actuator coupled to a lifting rod extending between the actuator and the hose cradle; and wherein the actuator is operable to selectively extend or retract the lifting rod and move the hose cradle in a vertical direction for moving the one or more hose between a lowered position and one or more elevated positions.

In embodiments, the one or more lifting mechanisms comprises a lifting arm and an actuator configured to move the lifting arm in the substantially vertical direction; and wherein the actuator comprises a manually operable jack mechanism, a pneumatic or hydraulic cylinder, or a motor.

According to another aspect, a method for positioning a hose at a hydraulic fracturing site comprises positioning a hose handling assembly between a pumping unit and a manifold assembly; coupling the hose to the pumping unit; positioning the hose within a hose cradle of the hose handling assembly; selectively moving the hose in a substantially vertical direction to an elevated position; selectively moving the hose in a substantially horizontal direction; selectively turning the hose about a substantially vertically extending axis; and selectively pivoting the hose with respect to the pumping unit.

In embodiments of the method, the hose cradle comprises a clamping mechanism; and wherein positioning the hose within the hose cradle comprises engaging the hose with the clamping mechanism so as to substantially fix the hose against movement in the substantially horizontal direction.

In embodiments of the method, selectively moving the hose in the substantially horizontal direction comprises engaging the hose with an injector drive mechanism and urging the hose in a forward direction or a reverse direction.

In embodiments of the method, the hose is caused to move in the substantially horizontal direction by movement of the hose in the substantially vertical direction.

In embodiments, the method further comprises coupling one or more additional hose to the hose to complete a fluid flow path between the pumping unit and the manifold assembly.

Accordingly, embodiments of hydraulic fracturing systems, including hydraulic fracturing hose handling assemblies, components, and methods thereof, which are directed to the above-discussed and other needs, are disclosed herein. The foregoing and other advantages and aspects of the embodiments of the present disclosure will become apparent and more readily appreciated from the following detailed description, taken in conjunction with the accompanying drawings. Moreover, it is to be understood that both the foregoing summary of the disclosure and the following detailed description are exemplary and intended to provide further explanation without limiting the scope of the present disclosure.

### BRIEF DESCRIPTION OF THE DRAWINGS

The accompanying drawings, which are included to provide a further understanding of the embodiments of the present disclosure, are incorporated in and constitute a part of this specification, illustrate embodiments of this disclosure, and together with the detailed description, serve to explain the principles of the embodiments discussed herein. No attempt is made to show structural details of this disclosure in more detail than may be necessary for a fundamental understanding of the exemplary embodiments discussed herein and the various ways in which they may be practiced; and it will be understood that the drawing figures are not necessarily to scale, and that certain features and components shown therein may be shown exaggerated in scale or in somewhat schematic form and some details of various elements may not be shown in interest of clarity and conciseness.

FIG. 1A is a perspective view of a hydraulic fracturing system including a fluid distribution manifold, pumping units, and hoses connecting the pumping units to the fluid distribution manifold.

FIG. 1B is a schematic illustration of a hydraulic fracturing system including a monobore type fluid distribution manifold and one or more hose handling assemblies for supporting hoses of the hydraulic fracturing system in accordance with the principles of the present disclosure.

FIGS. 2A-2B is a perspective view of an example monobore type fluid distribution manifold for a hydraulic fracturing system.

FIG. 3 is a perspective view of a monobore type fluid distribution manifold for a hydraulic fracturing system illustrating a plurality of hoses supported by embodiments of a hose handling assembly in accordance with the principles of the present disclosure.

FIG. 4A is a perspective view schematically illustrating an example embodiment of a hose handling assembly for supporting and facilitating movement of a hose of a hydraulic fracturing system in multiple directions in accordance with the principles of the present disclosure.

FIG. 4B is an end view the hose handling assembly of FIG. 4A, schematically illustrating an example embodiment of an injector drive mechanism for supporting and facilitating movement of a hose of a hydraulic fracturing system in multiple directions in accordance with the principles of the present disclosure.

FIGS. 4C-4D are side views of the hose handling assembly of FIGS. 4A-4B, schematically illustrating the movement of a hose of a hydraulic fracturing system in multiple directions using the hose handling assembly in accordance with the principles of the present disclosure.

FIG. 4E is top plan view of the hose handling assembly of FIGS. 4A-4D, schematically illustrating an example embodiment of an injector drive mechanism facilitating movement of a hose of a hydraulic fracturing system along a substantially horizontal plane in accordance with the principles of the present disclosure.

FIG. 5A is a side view schematically illustrating an additional example embodiment of a hose handling assembly for supporting and facilitating movement a hose of a hydraulic fracturing system in multiple directions in accordance with the principles of the present disclosure.

FIG. 5B is a perspective view of another example embodiment of a hose handling assembly for supporting and facilitating movement a hose of a hydraulic fracturing system in multiple directions in accordance with the principles of the present disclosure.

FIG. 6A is a perspective view schematically illustrating a further example embodiment of a hose handling assembly for supporting and facilitating movement of a hose of a hydraulic fracturing system in multiple directions in accordance with the principles of the present disclosure.

FIG. 6B is an end view the hose handling assembly of FIG. 6A, schematically illustrating the clamping and support of a hose of a hydraulic fracturing system in accordance with the principles of the present disclosure.

FIG. 6C is a side view the hose handling assembly of FIGS. 6A-6B, schematically illustrating the clamping and support of a hose of a hydraulic fracturing system in accordance with the principles of the present disclosure.

FIG. 6D is a top plan view of the hose handling assembly of FIGS. 6A-6C illustrating rotation of the hose.

FIG. 7A is a perspective view schematically illustrating still a further example embodiment of a hose handling assembly for supporting and facilitating movement of a hose of a hydraulic fracturing system in multiple directions in accordance with the principles of the present disclosure.

FIGS. 7B and 7C are side views of additional example embodiments of a hose handling assembly, schematically illustrating the engagement and support of a hose of a hydraulic fracturing system between a hose cradle and an additional guide in accordance with the principles of the present disclosure.

FIGS. 8A and 8B are side views illustrating an example embodiment of a hose handling assembly installed between a pumping unit and a manifold assembly of a hydraulic fracturing system in accordance with the principles of the present disclosure.

### DESCRIPTION

Embodiments of the present disclosure will now be described in more detail with reference to the attached drawing figures. It will be understood that the following description in combination with the Figures is provided to assist in understanding the embodiments and principles disclosed herein and should not be interpreted as a limitation on the scope or applicability thereof. Moreover, while the description and Figures make reference to various exemplary embodiments, it will be understood that the examples disclosed herein have broad application, and that the discussion of any embodiment is meant only to be exemplary of that embodiment, and not intended to suggest that the scope of the disclosure, including the claims, is limited to a specific embodiment or embodiments.

As used herein, the terms “comprises,” “comprising,” “includes,” “including,” “has,” “having,” or any other variation thereof, and are intended to cover a non-exclusive inclusion. For example, a process, method, article, or apparatus that comprises a list of features is not necessarily limited only to those features and may include other features not expressly listed or inherent to such process, method, article, or apparatus. Further, unless expressly stated to the contrary, “or” refers to an inclusive-or and not to an exclusive-or.

Dimensional information in the following description should be understood as nominal dimensions that are intended to encompass variations in dimensions that normally occur in the commercial production of components of hydraulic fracturing systems. Terms such as “approximately,” “about,” and “substantially” may be used to qualify dimensional information in the following description but such qualifications are intended merely to reinforce that the dimensions are nominal dimensions and not to differentiate qualified dimensions from unqualified dimensions.

The terminology used herein is for the purpose of description only and is not intended to be limiting of the present disclosure. Spatially relative terms, such as “beneath,” “below,” “lower,” “above,” “upper,” and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if a device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a,” “an,” and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

Various aspects and embodiments of the present disclosure are generally directed to hydraulic fracturing systems, and in some embodiments disclosed herein, to fluid delivery systems for delivering a pressurized fluid, such as a hydraulic fracturing fluid between a pumping unit and a manifold assembly at a hydraulic fracturing site; as well as to hose handling assemblies and components, and methods of use thereof in hydraulic fracturing systems and operations for supporting fluid supply hoses, and methods of operation thereof.

By way of example, fluid conveyance devices, such as hoses, conduits, tubing, flexible piping, etc., used in hydraulic fracturing systems and operations for delivery of a fluid media under pressure from a fluid supply to a fluid manifold, such as, for example, a monobore manifold, for supplying the pressurized fluid to one or more wellheads during a hydraulic fracturing application. Such fluid conveyance devices generally are difficult to move or position/reposition, particularly after the start of a hydraulic fracturing operation due to the substantial weight of such fluid conveyance devices when pressurized fracturing fluids are being pumped therethrough and given space constraints. Due to such substantial weight, and given limited space between fluid supply pumps and corresponding inlets or outlets of a manifold for distribution of the fracturing fluids to one or more wellbores, the fluid conveyance devices generally are laid on the ground, especially when extended lengths of hoses are required, subjecting the hoses to contact with contaminants, dirt, mud and debris, and generally creating a bends in the hoses and substantially non-1linear flow paths between the manifold and one or more fluid supply pumps.

The terms “fluid conveyance device” as used herein can refer to any type of device such as hoses, conduits, tubing, flexible piping, etc., adapted to convey or transport a fluid media, including, but not limited to, pressurized fracturing fluids. For purposes of illustration, the following discussion refers to “hoses,” which will be understood to apply to any type of fluid conveyance device.

As used herein, the terms “upstream” and “downstream” are used to denote the general flow direction of fracturing fluid through the outlet manifold hydraulic fracturing during operations, according to some embodiments. This convention is used herein for clarity and convenience when describing the outlet manifold and the components and assemblies thereof. An outlet is positioned at the downstream end that is fluidly connected to the wellhead.

The hose handling assemblies according to the principles of the present disclosure are configured to provide support for and facilitate movement of hoses, such as used in hydraulic fracturing operations to convey fracturing fluids, in multiple directions, thus enabling the hoses to be positioned and/or repositioned at a selected positions elevated above a ground surface, turned or rotated, pivoted, and moved back and forth in a substantially horizontal direction as needed for connection and alignment of the hoses with other components of hydraulic fracturing system, for example, for supporting the hoses above a ground surface, to provide for a substantially in-line or straight flow path for the fracturing fluids passing therethrough, and other benefits.

In embodiments, the hose handling assemblies can enable positioning/repositioning of a hose in at least three directions, and in embodiments, four directions. For example, the hose handling assemblies can enable movement of a hose a first direction (e.g., along a vertical plane in a vertical or Y-direction), a second direction (e.g., a rotational movement about a vertical axis Y), a third direction (e.g., along a horizontal plane in a horizontal or X-direction), and, in embodiments, in a fourth direction (e.g., a pivoting movement of the hose with respect to a ground surface and the hose handling assembly.

It will be understood that the embodiments of hose handling assemblies discussed below and as shown in the Figures are example embodiments for purposes of illustration and discussion, and that variations, modifications and changes can be made thereto in accordance with the principles of the present disclosure. In addition, while example configurations of a hydraulic fracturing system 10 and a monobore manifold are shown in the Figures, it will be understood that the hydraulic fracturing hose handling assemblies and methods, and components thereof, of the present disclosure can be used with a variety of hydraulic fracturing systems and fluid manifolds therefor.

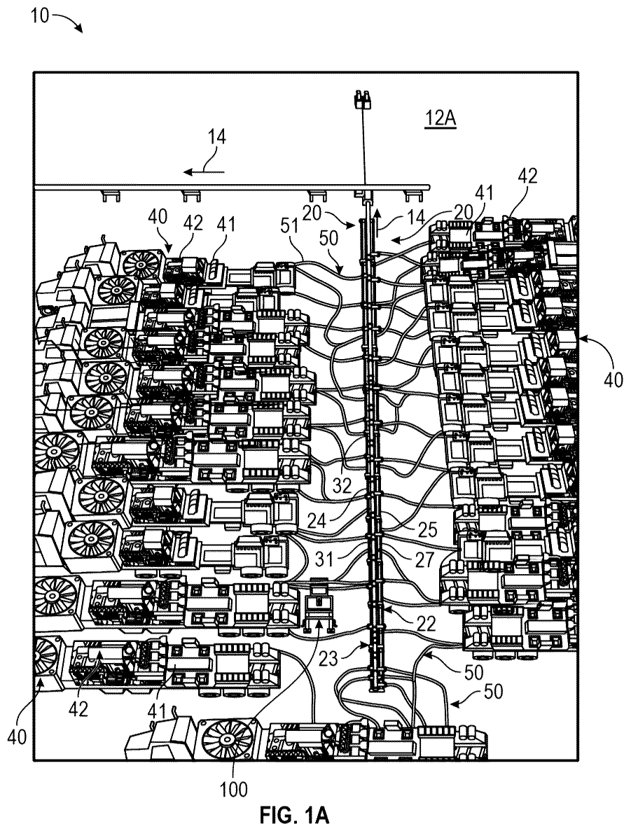

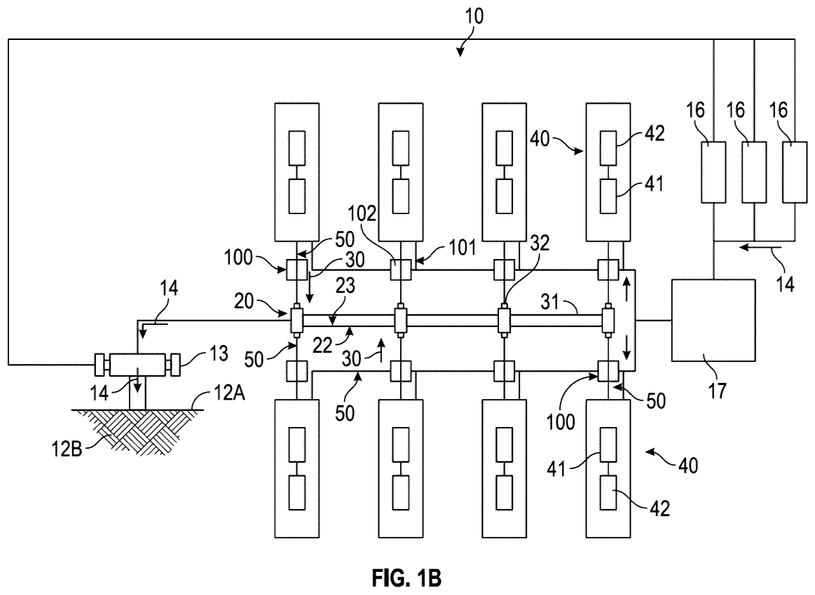

FIGS. 1A-1B illustrate an example of a hydraulic fracturing system 10 including a manifold assembly 20. During operations, the hydraulic fracturing system 10 may inject a high-pressure fracturing fluid (e.g., as indicated at arrows 14 in FIG. 1B) from a fluid supply 11 into a wellhead 13 that is connected to a wellbore extending below a ground surface 12A and into a subterranean formation 12B to fracture the subterranean formation 12B. In some embodiments, the hydraulic fracturing system may inject the high-pressure fracturing fluid into a plurality of wellheads so as to access the subterranean formation via a plurality of wellbores. In addition, lower pressure fluids can be extracted and conveyed from a low pressure side of the manifold assembly 20 to the fluid supply.

It should be appreciated that the example hydraulic fracturing system 10 shown in FIGS. 1A-1B. depicts only some components and assemblies that may be used during a hydraulic fracturing operation for purposes of illustration, and that in embodiments additional or fewer components may be used within the hydraulic fracturing system 10. Thus, the particular combination and/or arrangement of components of the hydraulic fracturing system 10 depicted in FIGS. 1A-1B are not limiting.

In embodiments, the fluid supply 11 of the hydraulic fracturing system 10 can include a plurality of fluid storage vessels 16 that are each configured to hold a volume of fracturing fluid therein. The fracturing fluid stored in the storage vessels 16 may include any fluid media, including a liquid or semi-liquid (such as a gel) fluid media that is suitable for injection into a subterranean formation for fracturing of the subterranean formation as previously described. In some embodiments, the fracturing fluid can include an aqueous solution including substantially pure water or water mixed with one or more additives (such as gels or gelling agents, chemicals, etc.). The storage vessels 16 also may include any suitable container for holding a volume of fluids therein. For instance, in some embodiments, storage vessels may include rigid tanks, flexible tanks (such as bladders), open pits, mobile tanks, that may be pulled by a vehicle such as a tractor trailer or other vehicle as indicated in FIG. 1A or a combination thereof.

In some embodiments, a blender 17 (FIG. 1B) can be positioned downstream from the storage vessels 16 and can be configured to mix a proppant into the fracturing fluid. Examples of a proppant may include sand or other suitable solids. The proppant will be configured to flow into the fractures within the subterranean formation 12B as to hold the fractures open after the hydraulic fracturing operation has ended. In some embodiments, additives (such as chemical additives) also may be mixed into the fracturing fluid within the blender either in addition or alternatively to the proppant. In embodiments, the fracturing fluid, with or without a proppant mixed therein, can be supplied to one or more of a plurality of pumping units 40, which pump the fracturing fluid under pressure to the manifold assembly 20 that communicates the fracturing fluid to the wellhead(s) 13.

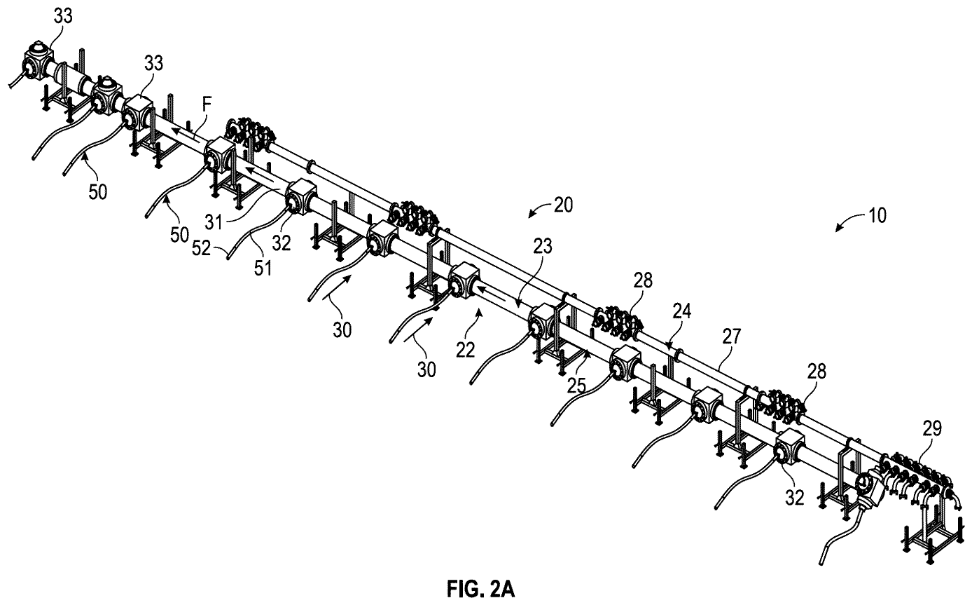

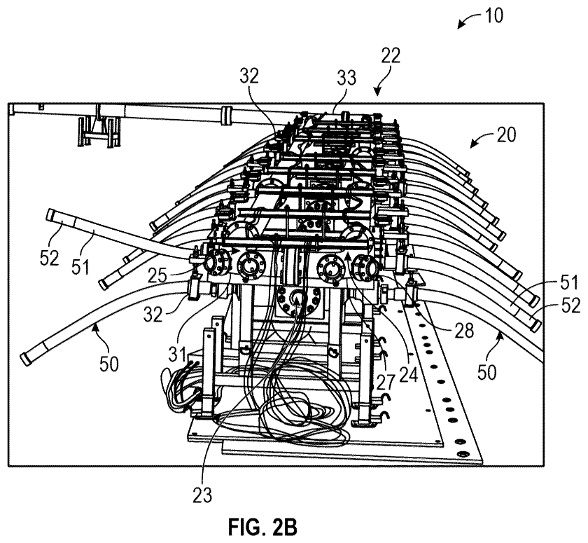

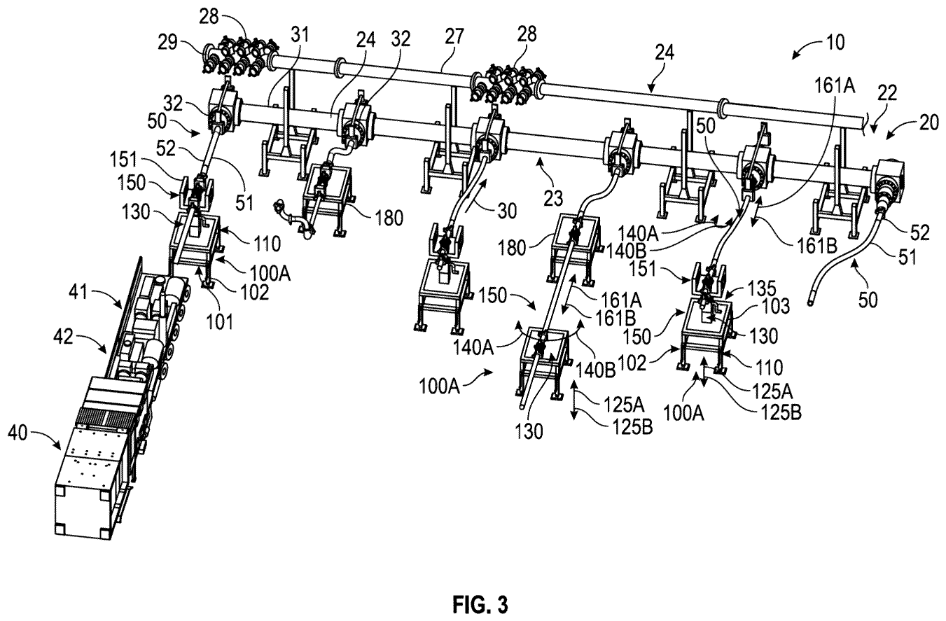

In embodiments, the manifold assembly 20 can include one or more fluid manifolds 22. For example, in embodiment, such as shown in FIGS. 2A-3, the manifold assembly 20 can include a monobore type fluid manifold 23 that can include one or more fluid delivery conduit, and which can have a low-pressure fluid section 24 and a high-pressure fluid section 25, as illustrated in FIGS. 2A-3. Examples of hydraulic fracturing systems including manifold assemblies, including monobore type fluid manifolds are disclosed in US Patent Pub. US2024/0344439, and PCT Publication No. WO2024059199A, the disclosures of which are incorporated by reference as if fully set forth herein.

In embodiments, as indicated in FIGS. 2A-3, the low-pressure fluid section 24 can include a low-pressure fluid delivery conduit or line 27, one or more low-pressure inlets 28, and multiple low-pressure outlets 29. The one or more low-pressure inlets can be configured to direct low-pressure fluid (e.g., low-pressure fracturing fluid) from a fluid source (e.g., one or more fluid storage vessels) to the low-pressure fluid delivery conduit 27, and the low-pressure outlets 29 can be configured to direct the low-pressure fluid from the low-pressure fluid delivery conduit to the pumping systems or units 40 (FIG. 3). In some embodiments, one or more low-pressure outlets can be positioned on a first lateral side of the low-pressure monobore fluid delivery conduit 27 of the manifold 23, and one or more low-pressure outlets can be positioned on a second, opposite lateral side of the low-pressure fluid delivery conduit.

In addition, in embodiments, the high-pressure fluid section 25 can include a high-pressure fluid delivery conduit or line 31, multiple high-pressure inlets 32, and one or more high-pressure outlets 33. The high-pressure inlets 32 generally will be configured to receive the high-pressure fluid (indicated by arrows 30 in(FIG. 1B) from the pumping units 40 for introduction of the high-pressure fluid to the high-pressure fluid delivery conduit 31 (FIGS. 2A and 3) high-pressure fluid is directed along the high pressure delivery conduit 31 to the one or more high-pressure outlets 33, which are configured to direct the high-pressure fluid toward the wellhead(s). In embodiments, one or more high-pressure inlets can be positioned along a first lateral side of the high-pressure fluid delivery conduit, and one or more additional high-pressure inlets can be positioned along a second, opposite lateral side of the high-pressure monobore conduit 31 of the monobore manifold 23.

As shown in FIGS. 1A-1B, a plurality of pumping units or systems 40 can be provided as part of the hydraulic fracturing system 10. In embodiments, the pumping units 40 can comprise stationary pumps, or can include mobile pumping units (e.g., transported by a vehicle as show in FIG. 1A). In embodiments, each pumping unit 40 can include a pump 41 driven by a driver 42 (which may be referred to herein as a “prime mover”). Each pump 41 may comprise any suitable fluid pumping device or assembly for pressurizing and pumping the fracturing fluid (with or without proppant and/or other additives entrained therein) to the pressures associated with a hydraulic fracturing operation. For instance, in some embodiments, the pumps 41 may be configured to pressurize the fracturing fluid (with or without proppant and/or other additives entrained therein) to an increased pressure (e.g., a pressure of about 9000 pounds per square inch (psi) or higher). The pumps 41 may include various types of high-pressure pumps, such as a “hydraulic fracturing pump” used for hydraulic fracturing operations. In some embodiments, pumps 41 may include positive displacement pumps, centrifugal pumps, or other suitable types of pumps.

In embodiments, the drivers 42 for the pumps may include any suitable motor or engine that is configured to drive or actuate a corresponding pump 41 during operations. For instance, in some embodiments, the drivers 42 may include a diesel engine, a turbine (such as a gas turbine, steam turbine, etc.), an electric motor, or some combination thereof. During operations, within each pumping unit 40, each driver 42 may actuate its pump 41 to draw fracturing fluid into the pump 41, pressurize the fracturing fluid, and output the fracturing fluid from the pump 41 to the monobore manifold 23 of the manifold assembly 20 via a corresponding conduit or hose 50 configured to deliver the fracturing fluid to a corresponding high-pressure inlet, as well as for return of fluids from the outlet conduit 25 to the fluid supply. The high-pressure fluid delivery conduit 27 of the monobore manifold 23 distributes and directs the pressurized fracturing fluid to the wellheads for injection into the subterranean formation as previously described.

In addition, during hydraulic fracturing operations, fracturing fluid may be emitted from the wellbore via the wellhead and can be received by the low-pressure inlets of the low-pressure fluid delivery conduit to be recycled back to the storage vessels through one or more recycle conduits or hoses 50. In some embodiments, the recycled fracturing fluid output from the wellhead may be routed through one or more filtering or separation assemblies or devices (not shown) to remove additives, proppant, and/or other fluids or solids (such as, rock chips, formation fluids, etc.) that may be entrained within the fracturing fluid, prior to recycling the fracturing fluid to the storage vessels.

As illustrated in FIGS. 2A and 3, the pumps 41 of the pumping units 40 generally will be connected to the high-pressure inlets 32 of the high pressure fluid delivery conduit 31 and the low-pressure outlets 29 of the low-pressure fluid delivery conduit 27 of the monobore manifold 23 by hoses 50, which can define fluid flow paths 30 along which high-pressure fracturing fluids are transferred from the pumping units to the high pressure inlets 32 of the monobore 23, and along which low-pressure recycled fluid is transferred from the low pressure outlets 29 to pumping units 40 and/or the to the fluid supply 11, such as being fed to one or more fluid storage vessels 16. Each of the hoses 50 can, in embodiments, include a flexible body 51, with couplings 52 at each end. The couplings will be configured to attach to the pumping units and the inlets and outlets of the monobore manifold 23, and to other hose sections.

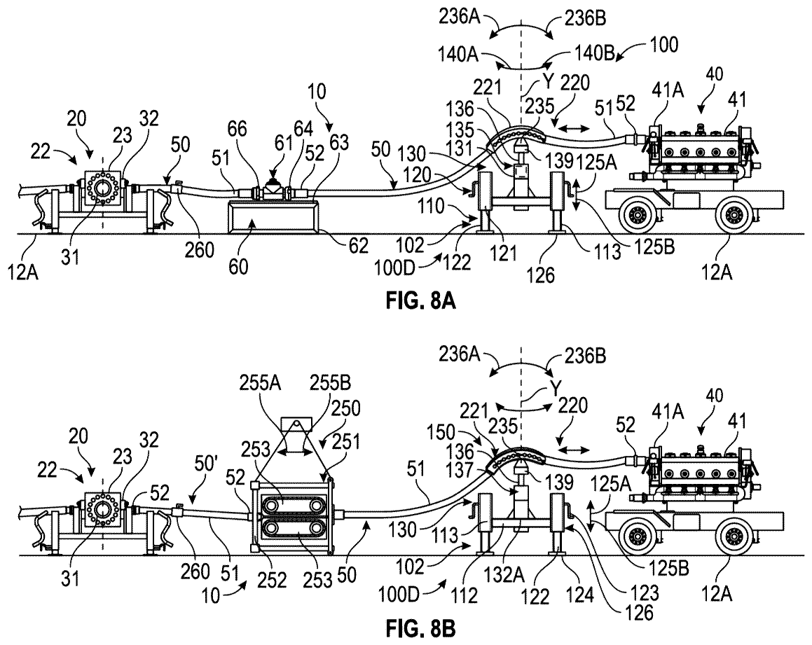

In addition, in embodiments, multiple hoses 50 may be connected in series to span a distance between the pumping units 40 and the high pressure inlets 32 and/or low pressure outlets of the monobore manifold 23, as needed to define or complete a flow path 30 extending from the pumping units to the high pressure inlets 32 and/or low pressure outlets of the monobore manifold 23. For example, in embodiments, the hoses 50 can be approximately 8 feet to 12 feet in length (though other lengths also can be used) and can be coupled together between the pumping units and the high pressure inlets and/or low pressure outlets. In some instances, the hoses can be connected to check valves 60 such as shown in FIG. 8A, while in some cases, one or more sections of hoses can be directly coupled together. As further shown in FIG. 8A, the check valves can be supported on stands 61, each of which can comprise a frame 62 having a platform 63 at an upper end thereof and on which a check valve 60 can be positioned, with hoses 50 connected to an upstream inlet 64 and a downstream outlet 66 of the check valve 60. In embodiments, the stands 61 can be positioned such that the hose 50 coming from the downstream outlet 66 of the check valve can be arranged in a substantially straight alignment between the check valve outlet and the corresponding inlet/outlet of the monobore manifold 23.

In hydraulic fracturing systems, such as shown in FIG. 1B, the hoses 50 generally will be placed directly on the surface of the ground where they can be exposed to corrosive materials, dirt, mud, and other contaminants etc., and often will be run/extended along curved or bent, substantially non-linear paths, which can create restrictions on the flow of the fluid therethrough. In addition, once installed, it is difficult to move or position/reposition the hoses without costly lifting equipment, such as cranes, due to the limited space and accessibility to the hoses at the site and the substantial weight of the hoses.

The hose handling assembles 100 of the present disclosure are directed to providing a more efficient, easier to use and assemble, and lower cost system for handling such hoses, which enables the hoses to be moved to and supported in positions above the surface of the ground, while also enabling manipulation and movement of the hoses in multiple directions as needed for positioning or aligning of the hoses, such as to arrange the hoses substantially in-line with the outlets of the pumps and inlets of the monobore manifold and thus provide a generally straight flow path 30 along the hose and between the pump outlets and their corresponding monobore manifold inlets. For example, in embodiments, the hose handling assemblies 100 can enable movement of hoses in a substantially vertical direction, a substantially horizontal direction, turning of the hoses about a substantially vertically extending axis, and pivoting of the hoses about a pivot point located along the hose handling assemblies to enable pivoting of the hoses with respect to a ground surface and/or with respect to an outlet of a pump of a pumping unit, as needed to align the hoses, and thus a flow path defined therethrough, substantially in line with the outlet of the pump.

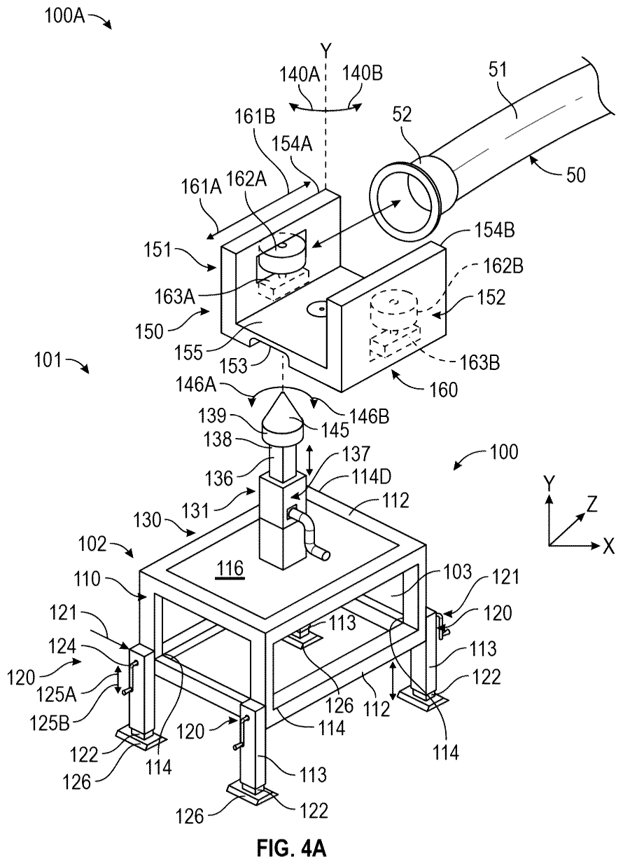

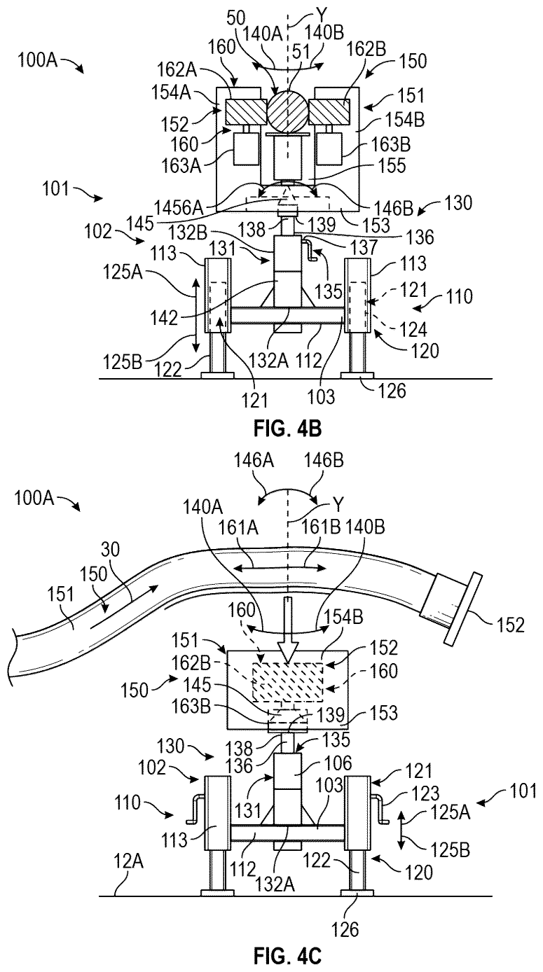

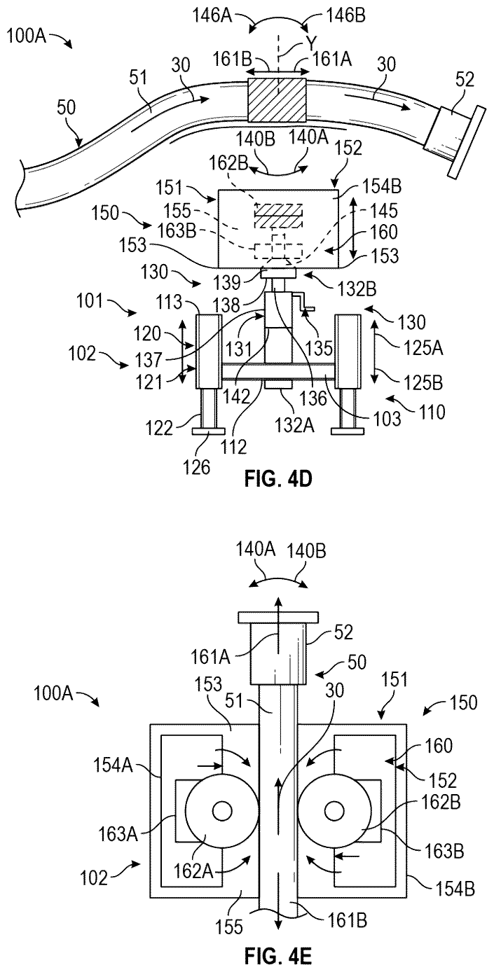

FIGS. 3-8B illustrate embodiments of hose handling assemblies 100 according to principles of the present disclosure. In embodiments, each hose handling assembly 100 can comprise a rack 101 (FIG. 4A) having a body 102 that defines a supporting framework for supporting a hose of the hydraulic fracturing system in a raised position above the surface of the ground. In embodiments, as indicated in FIG. 3 one or more hose handling assemblies 100 can be positioned between the pumping units 40 and the monobore manifold 23 and will be configured to support one or more hoses 50 in an elevated position above the surface of the ground at the fracturing site.

In embodiments, the body 102 of each hose handling assembly can include a skeletonized framework 103 that, in embodiments, can be formed a plurality of connected beams or supports. For example, as shown in FIGS. 3-4D and 5A-5B the framework 103 of the body 102 can include metal or metal alloy beams, bars, tubing, or other support members (e.g., steel, aluminum or other metals or metal alloy materials) defining an open sided frame. In addition, in some embodiments, the body can have a modular construction and can comprise one or more sections or modules that can be assembled and connected together to form the hose handling assembly 100, and thereafter can be disassembled for transport and storage; in some embodiments, the body sections can be configured to be stackable for further ease of transport and storage.

As illustrated in FIG. 4A, in one embodiment of a hose handling assembly 100A, the body 102 of each hose handling assembly 100A can include a first section or base 110, a second section or middle section 130, and a third or upper section 150, which can comprise or include a hose cradle 151 configured to receive a hose therein. In embodiments, the base 110 can include a substantially rectangular or square construction, such as shown in FIG. 4A. In other embodiments, or other configurations (e.g., cylindrical, pyramid shaped, etc.) that provide a stable support for the hose 50, and which, in embodiments, can provide for a substantially balanced distribution of the weight of the hose supported thereby can be used.

The base 110 further can include a plurality of side supports 112 and a series of legs 113 attached to the side supports. For example, as shown in FIG. 4A, the base can comprise a box frame, with four legs 113 can be connected to the base at corner portions 114 between the legs and side supports of the base. In other embodiments, additional or fewer legs can be used, depending upon the configuration of the base and/or body of the hose handling assembly 100A.

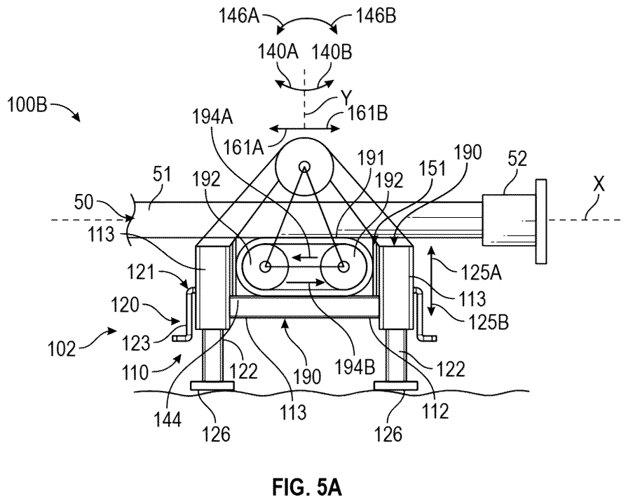

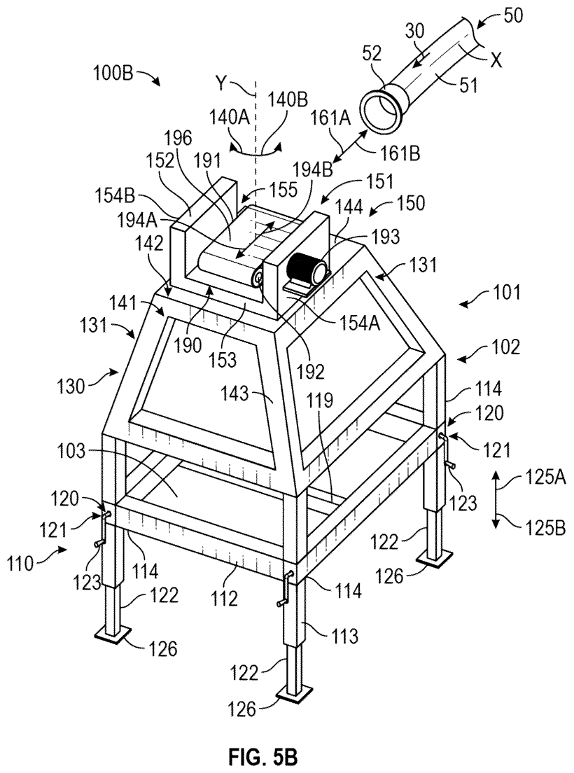

In addition, in some embodiments, such as illustrated in FIGS. 4A-4C, the base further can include a platform 116 positioned between the side supports 112 of the base so as to define a supporting surface 118 along an upper portion of the base. In embodiments the platform 116 can comprise a plate that can be fixed to the side supports 112, such as by welding, or by mechanical connection. Alternatively, in some embodiments, the base can be provided with an open center area, without a platform positioned in the center of the base, which can help reduce weight. In embodiments, one or more cross braces or center supports 119 (FIG. 5B) can be extended between the side supports 112 and can be attached thereto to provide additional support for the base, and, in some embodiments, can provide support for the second or intermediate section 130 of the body.

In embodiments, each of the legs 113 of the base further can include a lifting mechanism 120. For example, in some embodiments, each lifting mechanism 120 can be mounted to the side surface of each leg; while in other embodiments, the lifting mechanisms can be received within a channel or recess within the lower end of each leg 113. In some embodiments, fewer or more lifting mechanisms can be attached to the base.

In embodiments, such as shown in FIG. 3, the lifting mechanisms 120 can be actuated either manually or by a drivers such as a pneumatic or hydraulic cylinder, motor, or other driver, for moving the body 102 of the hose handling assembly 100A in a substantially vertical direction along a vertical axis Y (e.g., for raising and lowering the body), as indicated by arrows 125A and 125B, for movement of a hose 50 supported by the hose handling assembly between an initial, lowered position to one or more extended positions where the hose will be supported at an elevated position spaced above the surface of the ground.

In embodiments, the lifting mechanisms can each be selectively engaged and operated to facilitate positioning and/or repositioning of the hose at a selected elevated position with respect to a pumping unit and an inlet or outlet of the monobore to which the hose 50 is connected. The selective engagement of the lifting mechanisms also can help in leveling the body and to stabilize the body when positioned on uneven surfaces. In embodiments, one or more hose 50 will be received within the hose cradle 151 located at the upper section 150 of the body, and thereafter can be raised and lowered, even with pressurized fracturing fluid contained therein, by operation of the lifting mechanisms.

As illustrated in FIGS. 4A-4D, in some example embodiments, each lifting mechanism 120 can compromise a jack mechanism, such as, for example, a jack stand, bottle jack, screw jack, or other, similar jack mechanism. Other types of lifting mechanism (e.g., overhead lifting mechanism, etc.) also can be used. In embodiments, each of the lifting mechanisms will include an actuator 121 and a lifting rod 122 connected to the actuating mechanism 121. In embodiments, such as shown in, for example, FIG. 4A, the actuating mechanism can compromise a manually driven jack mechanism, operable by as a hand crank or other manual actuating mechanism 123. In other embodiments, the actuator 121 can include a pneumatic or hydraulic cylinder or a motor 124.

As indicated in, for example, FIG. 4A, in embodiments, the lifting mechanisms can be mounted internally, with the lifting rods being received and/or mounted within a recess or passage of each leg 113 of the base (e.g., as indicated by dashed lines in FIG. 4B) and being movable in a telescoping fashion into and out of the legs. In other embodiments, the lifting mechanisms can be mounted outside of the legs or in other positions spaced along the base.

Each lifting rod can be extendable/retractable and, in embodiments, can have a foot 126 attached at a distal end thereof. In embodiments, each foot 120 can be fixedly attached to the distal end of its lifting rod 122, or, in some embodiments, can be rotatably attached to the end of its lifting rod to enable the foot 126 to pivot or swivel in one or more directions as needed to help provide a secure placement engagement of the foot on uneven ground surfaces 124. Each foot further generally will be configured with a size (e.g., a length and width) selected to support the base to help ensure substantially stable footing for the body at each corner thereof.

As further illustrated by FIGS. 4A-4D, in embodiments, the second or intermediate section 130 of the body 102 of each hose handling assembly 100A can comprise a cradle support 131 including a first or lower end 132A that can be mounted to the base 10. For example, in embodiments, the cradle support can be mounted along a platform 116 of the base 102 or, in other embodiments to one or more cross braces 119 (FIG. 5B) of the base. As also indicated in FIGS. 4A-4D, the cradle support 131 can be rotatably coupled to the hose cradle 151 at a second or upper end 132B. In some embodiments, the cradle support 131 can comprise an upstanding support column or similar support such as indicated in FIGS. 4A-4D. Alternatively, in other embodiments, the cradle support 131 can be otherwise constructed, for example, comprising a frame or a platform 141 (FIG. 5B) mounted to the upper end of the base, 110 and having an upper portion 133A rotatably coupled to the hose cradle 151, and a series of extending legs or support post 134.

In addition, in embodiments the cradle support 131 (FIG. 4A) also can include or be provided with one or more lifting mechanisms 135 located therealong. For example, as indicated in FIGS. 4A-4D, a lifting mechanism 135 can be positioned between an upper and of the column of the cradle support 131 and the hose cradle 151. In various embodiments, the lifting mechanism 135 of the cradle support can be provided in addition to or as an alternative to the lifting mechanisms of the base, and in embodiments, can be used separately from or in conjunction with the lifting mechanisms 120 of the base 110. The one more lifting mechanisms 135 further can be selectively, engaged as needed for moving the hose in the first (e.g., vertical) direction; for example, when the hose 50 is required to be raised to an elevation higher than a full extension of the lifting rods of the lifting mechanisms 120 of the base 110.

As further illustrated in FIGS. 4A-4D, in embodiments, the lifting mechanism 135 can comprise a similar lifting mechanism as provided with the base. For example, in some embodiments, the lifting mechanism 135 can include a mechanism such as a jack stand or other, similar lifting mechanism. The lifting mechanisms 120 and can include a lifting rod 136 which can be attached to an actuator 137, such as a pneumatic or hydraulic cylinder, a motor, or a manual actuating assembly (e.g., a hand operable crank device). In some embodiments, the lifting mechanism 135 can be mounted to the upper end of the cradle support or, in other embodiments, can be received within a recess or internal passage defined within an upper portion of the cradle support 131.

As further illustrated in FIG. 4A, in embodiments, the distal or free end 138 of the lifting rod 136 can include a rotatable connection 139 that can couple the distal end 138 of the lifting rod 136 to a bottom section or base 153 of the body 152 of the hose cradle. The result, a rotating connection is established between the upper end of the cradle support 131 and the hose cradle 151 enabling the hose cradle, and thus a hose 50 received therein, to move in an additional, second direction of movement (e.g. enabling the hose 50 be rotated or turned (e.g., in a Z direction) about a substantially vertical axis Y in the direction of arrows 140A/140B) as needed to reorient or realign the hose with respect to a pumping unit and/or an inlet or outlet of the monobore.

Still further, as shown in FIG. 4A, in embodiments, the rotatable connector 139 further can be configured with or can include a pivoting connector 145 attached thereto at its upper end, and to the hose cradle 151. The pivoting connector 145 will be configured to enable that hose cradle 145 to be pivoted about a pivot point adjacent the upper end of the cradle support and with respect to a ground surface in the direction of arrows 146A and 146B, in addition to the rotation of the hose cradle in the direction of arrows 140A and 140B, the vertical movement of the hose in the direction of arrows 125A and 125B, and the horizontal movement of the hose in the direction of arrows 161A and 161B. As a result, the hose can be selectively moved in multiple directions (e.g., three-four directions) as needed for positioning and orienting the hose, and thus a fluid flow path defined therealong, with respect to an outlet of the pumping unit and an inlet of a manifold assembly, such as illustrated in FIGS. 8A-8B.

In additional embodiments of the hose handling assembly 100B, such as shown in FIG. 5B, the cradle support 131 can be constructed with a frame 141 that can include an upper portion 142 to which the hose cradle 131 can be rotatably mounted, and a series of legs or support posts 143 attached to the upper portion 142 and to the base 110 of the body 102. In embodiments, the upper portion 142 can include a platform 144 that can be seated on top of and can be attached to the legs 143. In some embodiments, the legs 143 can be attached to the upper portion of the base such as by welding. In other embodiments, the legs can be releasably coupled to the base by mechanical connections configured to enable disassembly and removal of the cradle support from the base. In other embodiments, the legs 143 of the cradle support of FIG. 5B can be movable with respect to the base 110. For example, in embodiments, the legs 143 can include telescoping portions that can be extended and retracted for moving the cradle support and/or hose cradle in the vertical direction as indicated by arrows 125A/125B.

In addition, in embodiments, one or more lifting mechanisms 135 as discussed above can be mounted to the platform 142 or along the legs 143 for moving. In embodiments, each of the one or more lifting mechanisms 135 generally can include a lifting rod 136 and a pneumatic or hydraulic actuator or manual actuation mechanism 137 for directing the extension and retraction of the lifting rods. In some embodiments, lifting mechanism 135 can be connected to the upper portion 142 of the cradle support 131 and to the cradle hose to the base for lifting either the hose cradle or the platform of the cradle support; while in other embodiments, the lifting rods or actuators can be coupled to the upper portion of the base and can be actuated for lifting the entire frame of the cradle support.

Thus, one or more lifting mechanisms can be positioned along at least a portion of the frame of the cradle support and can be operated to selectively move the platform 144 of the cradle support, or the hose cradle 151, vertically. As a result, the hose will be moved the first direction (e.g., in a substantially vertical or Y-direction) as needed to position the hose at a selected or desired elevation with respect to the pumping units and/or an inlet or outlet of the monobore manifold to which the hose is connected, such as indicated in FIG. 8B.

As further illustrated in FIG. 5B, the hose cradle 151 can be rotatably mounted to the base. For example, in embodiments, the hose cradle 151 can be rotatably attached to an upper surface 147 of the base 110, such as by a connector that can be configured to enable a rotational movement of the hose cradle for turning the hose, and, in embodiments, also could include a pivoting connector to enable pivoting of the hose cradle as needed. In some embodiments, the hose cradle can be rotatable attached to and supported by an overhead frame 146, such as by a rotatable connector. As a result, the hose cradle is provided with a pivotable or rotating movement so as to enable turning of the hose, as indicated by arrows 140A and 140B, and pivoting of the hose as needed for repositioning or realigning the hose and the flow path defined therealong with respect to an outlet of the pumping unit and/or an inlet of the manifold assembly to which the hose is connected.

In a further alternative embodiment, such as schematically illustrated in FIG. 5A, the hose handling assembly 100B can comprise a rack having a body 102. The body can include two or more sections, including a base 110 and a cradle support 131 that can be formed pivotally attached to the base, or to an overhead frame 146 mounted to the base. One or more lifting mechanisms 120 also can be provided along each of the legs 113 of the base 110 for moving the hose carrier in the vertical or Y-direction along the Y-axis, as indicated by arrows 125A and 125B. In some example embodiments, the lifting mechanisms can include various types of jack mechanisms or other, similar lifting devices as discussed.

FIGS. 4A, 4B and 4E illustrate and example embodiment of a hose cradle 151 that can comprise the third or upper section 150 of the body 102 of the hose handling assembly 100A. In an embodiment, the hose cradle 151 can include a substantially U or C shaped configuration including a body 152 having a base or lower section 153 and opposed side sections 154A/154B defining a substantially U-shaped channel or passage 155 through the hose cradle and in which the hose 50 will be received. Additionally, in embodiments, the base 152 can be adjustable for supporting the hose, such as during movement of the hose through the hose cradle in a third direction of movement (e.g., movement of the hose in a substantially horizonal or X-direction).

In embodiments, the hose cradle 151 further can include an injector drive mechanism 160 that can be mounted along and/or positioned within the body 152 of the hose cradle. The injector drive mechanism will be adapted to drive the movement of the hose 50 in the horizontal or X-direction as indicated by arrows 161A and 161B in FIG. 4E, for positioning/repositioning the hose in the horizontal or X-direction as needed or desired.

In embodiments, as indicated in FIGS. 4B and 4E, the injector drive mechanism 160 can include one or more drive wheels 162A/162B connected to one or more drivers, such as motors 163A/163B. For example, FIGS. 4B and 4E illustrate the use of a pair of motors 163A/163B positioned along the side sections 154A/154B of the hose cradle 151 engage the sides of the body of the hose 50 extending through the channel 156 of the hose cradle. While each of the drive wheels 162A/162B further is shown to be connected to its own drive motor 163A/163B, in embodiments, the drive wheels 162A/162B can be coupled to the single drive motor.

In addition, in some other embodiments, a single drive wheel 162A/162B can be used. For example, the drive wheel 162A shown on the left side of the hose cradle 151 in FIG. 4E could be configured as a driven wheel connected to and driven by an associated motor 163A, while the opposite wheel, e.g. drive wheel 162B shown the right side of the hose cradle 151 in FIG. 4E, can comprise an idler wheel that can be rotated with the rotation of the driven wheel 162A without being directly driven by a motor. In a further alternative embodiment, the second drive wheel or idler wheel 162B (e.g., the drive wheel on the right side of FIG. 4E), can be replaced with a guide surface such a plate or other guide surface against which the hose can be engaged.

In embodiments, for example, as shown in FIGS. 4A and 4B, the drive wheels can be located along the channel of the hose cradle in positions spaced apart so as to enable the hose to be received therebetween. In embodiments, one or both of the drive wheels 161A/162B can be moved into contact with opposite sides of the body of the hose so that the hose is engaged between the drive and the idler wheels in a light frictional engagement so that as the drive wheels are rotated, the hose can be driven in a horizontal or X-direction along a horizontal plane in the direction of arrows 161A and 161B. In some embodiments, one or both of the side sections 154A/154B can be moveable toward and away from each other (with the drive wheels and motors positioned therealong being carried therewith) to expand or narrow the channel 155 as needed to facilitate placement and engagement of a hose therebetween, and for removal of the hose from the hose cradle.

FIGS. 5A-5B illustrate an additional embodiment of a hose handling assembly 100B including an injector drive mechanism 190 for controlling a horizontal movement of the hose. In embodiments, such as shown in FIG. 5B, the injector drive mechanism 190 can be incorporated into or positioned along an elongated platform 195 that comprises part hose the cradle as part of the body 102 of a hose handling assembly 100B. Alternatively, in some embodiments, the injector drive mechanism can be positioned externally of the body of a hose handling assembly, for example being positioned on a separate stand or support 180 that can be located adjacent the body of the hose handling assembly (e.g., as shown in FIG. 8B).

In embodiments, the injector drive mechanism 190 shown in FIGS. 5A-5B can include a drive belt or track 191 extending between a pair spaced sprockets or gears 192. In addition, in some embodiments such as illustrated in FIG. 8B, a pair of opposed drive belts or tracks can be used, with the opposed drive belts defining a channel or passage 197 through which the hose is received and engaged along opposite sides of the hose body by drive belts.

In embodiments, the belt 191 can be connected to a motor 193 (FIGS. 5A-5B) which can drive the drive belt 191 in forward and reversed directions as indicated by arrows 194A and 194B. Alternatively, the drive belt 191 of the injector drive mechanism 190 can be manually driven. In addition, as indicated in FIG. 5B, in embodiments, the drive belt further can include a gripping surface 196 adapted to engage and/or grip the body 51 of the hose 50 such that as the drive belt is driven in its forward and reverse directions the hose can be moved through the hose cradle in a substantially horizontal or X-direction along a horizontal plane as indicated by arrows 194A and 194B. In embodiments, the gripping surface can be formed as tracks, teeth, or ridges, while in other embodiments, the drive belt can include a material having a high coefficient of friction. Still further, where a pair of drive belts are used, such as shown in FIG. 8B, the drive belts can be moved into engaging contact with the body of the hose and can be driven in opposite directions to pull or urge the hose in the horizontal direction.

In addition, in some embodiments, the hose cradle 151 could be attached to a lifting mechanism mounted to the upper surface of the base, which can enable the movement of the hose in the vertical or Y-direction to further extended elevation position as needed, and which can be rotatably connected to the base of the cradle for enabling rotational or pivoting movement of the cradle, and thus the hose received therein.

Alternatively, the hose cradle could be coupled to an overhead framework connected to and supported by the base to provide for rotating or pivoting motion of the hose cradle and the hose supported thereby, such as indicated in FIG. 5A. For example, the hose cradle can be coupled to an overhead support assembly, which, in embodiments, could include a hoist or a winch, or a similar lifting mechanism. Still further, in some embodiments, the hose cradle can be pivotally connected to the overhead support assembly so as to enable a pivoting motion of the hose cradle in the direction of arrows 146A and 146B.

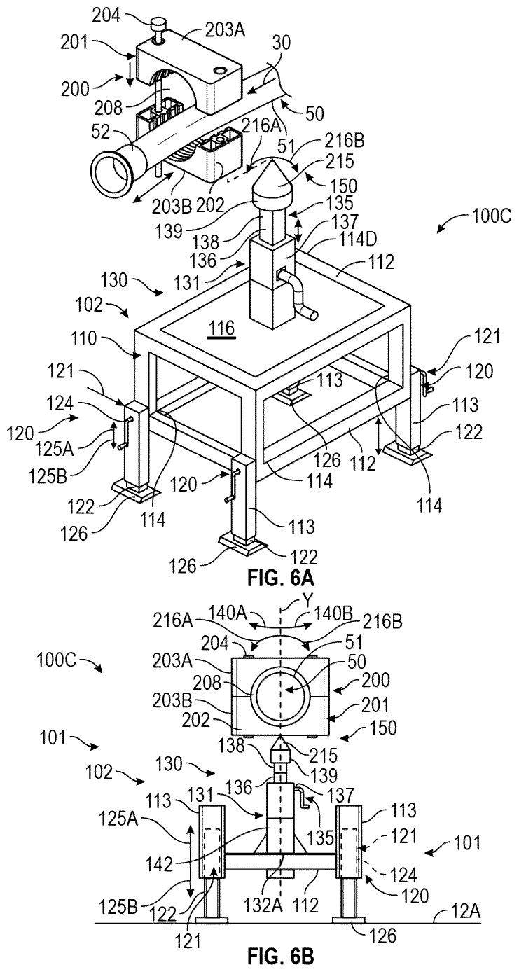

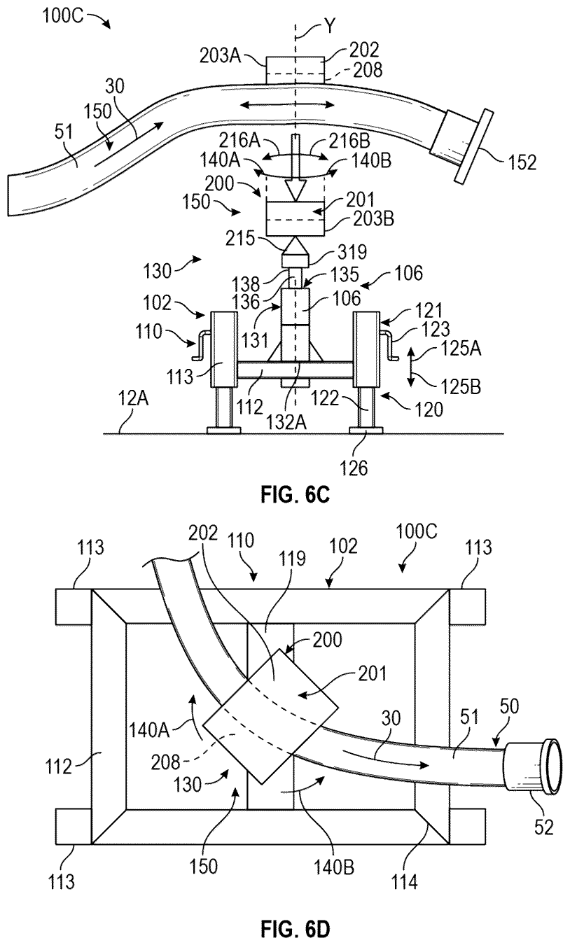

FIGS. 6A-6D illustrate a further embodiment of a hose handling assembly 100C according to the principles of the present disclosure. In the embodiment shown in FIGS. 6A-6D, the hose handling assembly 100C includes a body 102 including a first section or portion comprising a base 110, a second or intermediate section 130 comprising a cradle support 131, and a third or upper section 150 including a hose cradle 200. In this embodiment, the hose cradle 200 comprises a clamping mechanism 201.

As illustrated in FIG. 6A, in embodiments, the clamping mechanism 201 generally can include a body 202, which can include a pair of opposed sections 203A and 203B. The sections 203A and 203B can be coupled together, for example, by fasteners or connectors such as screw type connectors, generally indicated at 204 in FIG. 6A, so as to enable the sections 203A/203B of the body 202 to be brought into clamping engagement with the body 51 of a hose 50 extending therethrough. In embodiments, other connecting mechanisms, including rods and the like, which can be manually engaged or driven by an actuator such as a cylinder or a motor, also can be used.

As indicated in FIGS. 6A and 6B, the body 202 of the clamping mechanism 201 of the hose cradle 200 further can be pivotally or rotatably mounted to the cradle support 131, such as by being coupled to rotatable connector 139 to enable turning of the hose. For example, the hose cradle 220 can be rotatably coupled to the second end of a lifting rod 136 of a lifting mechanism 135 positioned along the cradle support 131 by the rotatable connector 139 to enable rotation or turning of the hose as indicated by arrows 140A/140B.

In addition, as shown in FIG. 6A, in embodiments, the rotatable connector 139 further can be configured with or can include a pivoting connector 215 attached thereto at its upper end, and to the hose cradle 200. The pivoting connector 215 will be configured to enable that hose cradle 200 to be pivoted about the upper end of the cradle support and with respect to the ground surface in the direction of arrows 216A and 216B, in addition to the rotation of the hose cradle in the direction of arrows 140A and 140B, the vertical movement of the hose in the direction of arrows 125A and 125B, and the horizontal movement of the hose. As a result, the hose can be selectively moved in multiple directions (e.g., three-four directions) as needed for positioning and orienting the hose, and thus a fluid flow path defined therethrough, with respect to an outlet of the pumping unit and a corresponding inlet of the manifold assembly inlet.

As indicated FIGS. 6A-6C, in use, a hose can be extended through a passage 208 defined between the sections 203A and 203B of the body 202 of the clamping mechanism 201. With the body of the hose received within the passage, the sections of the clamping mechanism can be brought into engaging contact with the body of the hose so as to substantially fix the hose in a position along a substantially horizontally extending plane. Thereafter, the hose can be raised or lowered in the direction of arrows 125A/125B so as to position the hose at a selected position elevation above the surface of the ground. In addition, as illustrated in FIG. 6D, in embodiments, the hose 50 also can be turned or rotated in the direction of arrows 140A and 140B and pivoted in the direction of arrows 216A and 216B as needed to reorient or realign the hose, and thus a flow path 30 defined therethrough, as shown in FIGS. 8A-8B.

In embodiments, the hose 50 (FIGS. 6A-6C) can be initially clamped and held against horizontal movement by the clamping mechanism prior to raising the hose to its elevated position, so as to substantially resist horizontal movement of the hose that could cause the hose to decouple or become disconnected from, for example, an outlet 41A (FIGS. 8A-8B) of a pump 41 of a pumping unit. Alternatively, in embodiments, the hose can be initially positioned within, for example, the first or lower section 203A (FIG. 6A) of the clamping mechanism 201 after being moved in a substantially vertical direction to its selected elevated or raised position.

During such substantially vertical movement, the hose can be allowed to shift or move in a substantially horizontal direction. The hose cradle further can be pivoted with respect to cradle support and the ground surface as the hose is raised, enabling the hose to become sloped as needed, without creating sharper bends that could potentially cause obstruction of the fluid flow path defined therethrough. After the hose has been located at its selected elevated position, the second or upper section 203B of the clamping mechanism can be engaged and secured against the lower section 203A so as to substantially fix the hose against further movement along a substantially horizontally extending plane. In embodiments, movement of the hose in a substantially vertical direction in the direction as indicated by arrows 125A and 125B, as well as rotational or turning movement of the hose in the direction of arrows 140A and 140B, can still be permitted while the hose remains secured by the clamping mechanism 201.

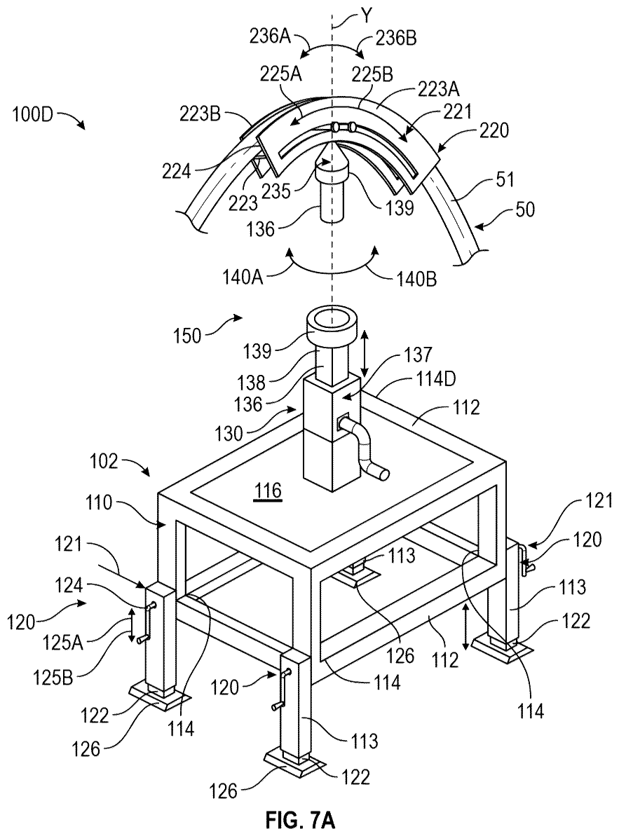

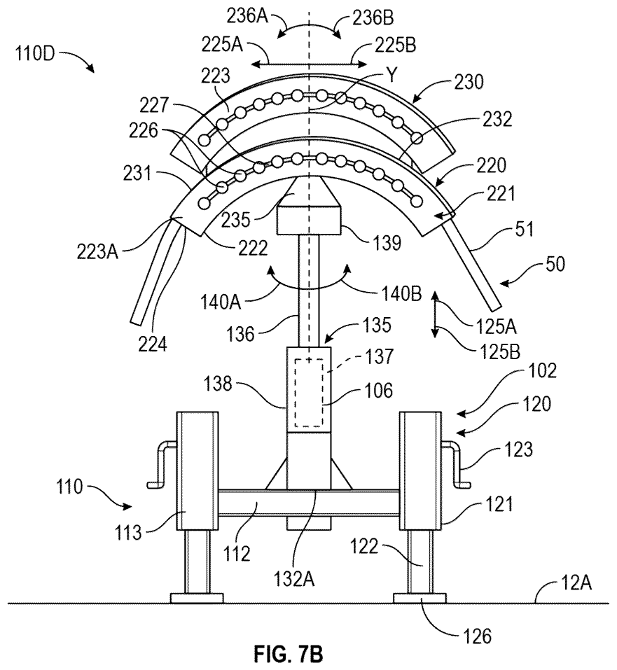

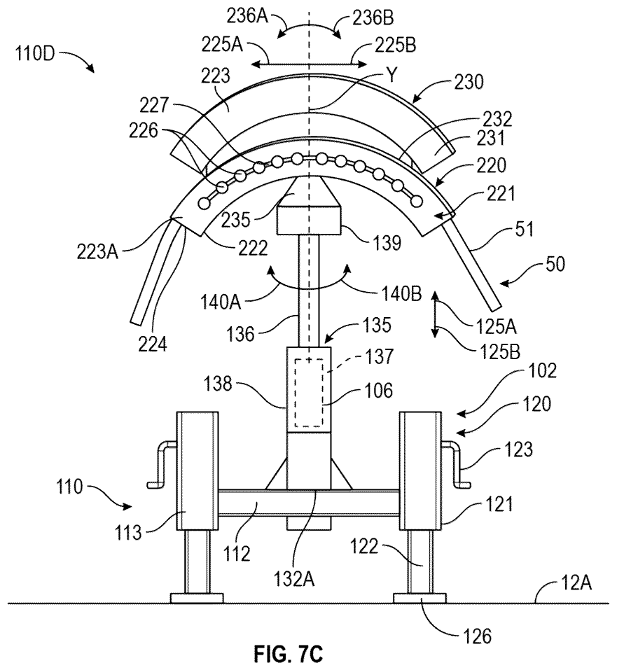

FIGS. 7A-8B illustrate additional embodiments of the hose handling assembly 100D in accordance with the principles of the present disclosure. In the embodiments of FIGS. 7A-8B, hose handling assembly 100B comprises a body 102 including a first section or base 110, a second or intermediate section 130, which can comprise a cradle support 131, and a third or upper section 150, including a hose cradle 220. One or more lifting mechanisms also will be provided. the lifting mechanism can be actuated to move the cradle, and thus the hose received therein, in a substantially vertical direction as indicated by arrows 125A and 125B. For example, in embodiments, one or more lifting mechanisms 120 can be provided along the legs 113 of the base 110, and/or a lifting mechanism 135 can be provided along the cradle support 131. In embodiments, the lifting movement of the hose cradle and hose in a substantially vertical direction can be controlled by controlling the lifting mechanisms 120 positioned along the base 110, alone or in conjunction with the lifting mechanism 135, or by control of the lifting mechanism 135 alone.

In the embodiments of FIGS. 7A-8B, the hose cradle 220 can comprise a substantially curved or arcuate shaped body 221 having a base or lower portion 222 and opposed sides 223A/223B defining a curved or arcuate channel 224 therebetween. A hose 50 can be received within the channel 224 and can be movable therealong in a substantially horizontal direction, rotated or turned, and pivoted as needed to position and orient the hose.

In addition, in some embodiments, such as shown in FIGS. 7B-7C, a plurality of rollers 226 can be positioned along the lower portion of the channel 224 adjacent the base of the hose cradle 200. In embodiments, the rollers 226 can be received within a channel 227 extending along the sides of the body 220. In addition, in some non-limiting embodiments, the rollers 226 can include a series of cylindrical rods, wheels, bearings, belts, or other conveying device configured to facilitate movement of the hose through the hose cradle in the direction of arrows 225A/225B. In other embodiments, various other types of bearing assemblies (such as linear bearing slides) or other mechanisms configured to facilitate sliding movement of the hose along the channel 227 also can be used. For example, in some embodiments, the upper surface of the base portion of the body could have a layer, sheet, or coating of a low coefficient of friction material applied thereto and which can be configured to facilitate sliding movement of the hose along the base. Such a coating material also can help provide wear resistance to the base (e.g., acting as a sacrificial wear surface), and can be reapplied as needed.

In addition, in some embodiments, an additional guide 230 (FIGS. 7B-7C) can be positioned over the top of the body 221 of the hose cradle 220 and configured to prevent displacement of the hose upwardly and out of the channel of the hose cradle 220. In embodiments, the additional guide 230 can have a similar arcuate profile as the body with a top portion 231 and opposing side portions 232 that define a channel therethrough. In embodiments, such as shown in FIG. 7B, the additional guide further can include plurality of rollers or bearings 226, which will be positioned opposite and spaced from the rollers 226 of the body 221. The hose 50 can be captured and engaged between the opposing sets of rollers 226 to facilitate movement of the hose through the hose cradle 220.

In other embodiments, such as illustrated in FIG. 7C, the additional guide 230 can be provided without rollers. In such instances, the top portion 231 of the additional guide 230 can be spaced from the channel 224 of the hose cradle 220, functioning to help maintain the hose within the channel during movement of the hose cradle and thus the hose in multiple directions. For example, in embodiments, the hose can be moved in a substantially vertical direction, in a substantially horizontal direction, turned or rotated about a vertical axis, pivoted about a pivot point along the cradle support and with respect to the ground surface, or combinations thereof). In some embodiments, the additional guide 230 can include a surface with a low coefficient of friction and can be applied along a lower surface of the top portion 231 of the additional guide 230. For example, in embodiments, a wear layer or coating material can be applied to help facilitate a sliding movement of the hose therealong.

In addition, as further shown in FIGS. 7A-7C, the hose cradle 200 also can be pivotably and rotatably connected to the cradle support 131. For example, the hose cradle 220 can be rotatably coupled to the second end of a lifting rod 136 of a lifting mechanism 135 positioned along the cradle support 131 by rotatable connector 139 to enable rotation or turning of the hose as indicated by arrows 140A/140B. In addition, in embodiments, the rotatable connector 139 can be configured with or can have a pivoting connector 235 attached thereto and to the hose cradle 220, as indicated in FIG. 7A. The pivoting connector will enable that hose cradle 220 to pivot about a pivot point located at the upper end of the cradle support in the direction of arrows 236A and 236B, in addition to the rotation of the hose cradle in the direction of arrows 140A and 140B, and the vertical movement of the hose in the direction of arrows 125A and 125B.

Still further, in some embodiments, a drive mechanism can be provided, and can be connected or coupled to the rollers 226 of the hose cradle. In other embodiments, such as shown in FIG. 8B, the drive mechanism can be provided as a separate drive, spaced from the body of the hose handling assembly. The drive mechanism can be configured to cause rotation of the rollers for urging the hose along the hose cradle in the direction of arrows 225A/225B for positioning or repositioning the hose along a substantially horizontal plane, as needed. As a result, the hose can be selectively moved in multiple directions (e.g., three-four directions) as needed for positioning and orienting the hose with respect to the outlet of the pumping unit and a corresponding inlet of the manifold assembly.

FIGS. 8A and 8B illustrate examples of the positioning and use of a hose handling assembly as part of a hydraulic fracturing system and operation. for purposes of illustration only, the embodiment of the hose handling assembly 100D shown in FIGS. 7A and 7B is shown. As illustrated in FIGS. 8A and 8B, the hose handling assembly 100D can be positioned between a pumping unit 40 and a manifold assembly 20 of the hydraulic fracturing system 10. A hose 50 or a section of a hose 50 can be passed along the channel of the hose cradle 220, which, in embodiments, and depending on the hose length, can be accomplished manually and e.g., by one to two workers, without necessarily needing the assistance of heavy lifting equipment).

After being loaded in the hose cradle, the hose can be moved in a substantially vertical direction to a selected elevated position with respect to the outlet 41A of a pump 41 of the pumping unit 40. In embodiments, the hose can be lifted to a raised or elevated position sufficient to locate the hose substantially in-line with the outlet of the pump 41, and with the hose sloping downwardly from the outlet 41A through the hose handling assembly and toward the inlet of the manifold assembly without having to be positioned along the ground surface 12A.

In some embodiments, the raising of the hose via the hose handling assembly 100D can cause the hose to move in a substantially horizontal direction, which, in some embodiments, can be sufficient to position the hose in a selected position along a substantially horizontal plane. However, in some embodiments, the lifting/substantially vertical movement of the hose can cause the hose to move away from the outlet 41A, and, in such embodiments, a drive 250 mechanism can be used for movement of the hose in the substantially horizontal direction.

As shown in FIG. 8A, in some embodiments where additional hoses 50′ or sections of hose may need to be coupled together and provide sufficient length extending from the pumping unit to the manifold assembly, the end of the hose 50 can be coupled to an additional or next hose section 50 such as via a check valve 60. In some embodiments, the check valve 60 can be positioned and supported on a platform 63 of a stand 61. The hose 50 can be connected to an upstream inlet 64 of the check valve, and the additional hose or hose section 50′ can be connected to a downstream outlet 66 of the check valve 60. In embodiments, the stand 61 can be positioned such that the hose 50′ coming from the downstream outlet 66 of the check valve 60 can be arranged in a substantially straight, in-line alignment between the check valve outlet and a corresponding inlet/outlet of the manifold assembly so as to form and/or complete a flow path between the pumping unit and the manifold assembly.

In other embodiments, such as indicated in FIG. 8B, an injector drive mechanism 250 can be coupled to the body or can be positioned adjacent to the body 102 of the hose handling assembly 100D as a separate drive mechanism. For example, as shown in FIG. 8B, the injector drive mechanism 250 can comprise a tractor stand 251 that can be positioned between the hose handling assembly and the manifold assembly. In other embodiments, the drive mechanism 250 also could be positioned in other locations.

In embodiments, the drive mechanism 250 can include a body 252, and one or more drive belt or a pair of drive belts 253 configured to engage and grip body of the hose. For example, in embodiments, an injector drive mechanism 190 as illustrated in FIGS. 5A-5B can be provided. As shown in FIG. 8B, the drive belts 253 can be positioned so as to define a central passage 254 therebetween, along which the body 51 of hose will be received. The drive belts further can be extended about a pair of sheaves or gears 256 that can be driven by a motor or similar actuator, or, in some embodiments, could be manually driven. The belts 253 can be driven in forward and reverse directions, as indicated by arrows 255A and 255B, so as to move the hose in a substantially horizontal direction as needed for positioning the hose, or one or more sections thereof, between the pumping unit and manifold assembly.

In addition, in some embodiments, a hose handle 260 can be provided. In embodiments, the hose handle 260 can comprise a releasable clamp or similar device that can be coupled along the body of the hose, for example, adjacent a connector 52, for assist in lifting the hose by workers. In embodiments, the hose handle is releasably connectable along the body of the hose so as to be moveable and detachable along any portion of the body of the hose. In addition, multiple hose handles also can be provided.

As indicated in FIG. 8B, the injector drive mechanism 250 will be configured to enable movement and positioning of a hose and along a substantially horizontal plane, including, in some embodiments, movement of the hose after the hose has been raised to its elevated position. For example, in some cases, the hoses can weigh as much as 600-800 pounds, particularly when extended lengths hoses are required. As a hose is raised by the hose handling assembly, the hose typically will move in a horizontal direction in response to the vertical movement thereof, causing the hose to shift or move away from the fluid end connection to the outlet 41A of the pumping unit 40 or away from the inlet 32 of the manifold assembly 20. By positioning the injector drive mechanism 250 downstream from the hose handling assembly, the weight of the hose(s) can be spread apart such that the stand on which the injector drive mechanism (e.g., the tractor stand) is positioned and the hose handling assembly will support the majority of the weight of the hose(s), enabling manual lifting and maneuvering of the hose for connection to the manifold assembly.

In addition, in embodiments, the tractor stand or injector drive mechanism can be used as a central pivot point and hose support to reduce overall hose weight at the ends thereof. The separately located injector drive mechanism 250 further will facilitate the connection of the end of the hose to the inlet of the manifold system by generally being operable to pull or urge the hose toward the manifold assembly such that hose can be pushed into place for easy connection by one or two workers.

In embodiments, the hose handling assemblies according to the principles of the present disclosure are configured to enable movement of one or more hoses supported thereby in multiple directions. For example, the hoses can be received and supported by the hose handling assembly can be moved in a first direction, for example, in a substantially vertical direction (e.g., a Y-direction) to position the one or more hoses at selected or desired elevation with respect to the ground surface and/or to the pumping units and corresponding inlets or outlets of the manifold. The hose handling assemblies additionally can enable movement of the hoses in a second direction, wherein the one or more hoses can be rotated or turned about a substantially vertical axis (e.g., movement about the Y-axis in a Z-direction), and also can enable movement of the hose(s) in a third movement direction, (e.g., in a X-direction along a substantially horizontal plane). Still further, the hose handling assemblies can enable movement of the hose(s) is a fourth direction (e.g., enabling the hose(s) to be pivoted with respect to an outlet of a pumping unit and/or an inlet of a manifold assembly). As a result, the hoses can be positioned and supported in an alignment of ground surface, with a substantially straight line flow path defined therethrough, which position can be adjusted and the one or more hoses repositioned as needed, even after a hydraulic fracturing operation has begun and the hoses are substantially filled with pressurized fracturing fluid.

By way of example only, in embodiments of a method of use of the hose handling assemblies 100A-100D shown in FIGS. 3-8B, the body 102 of the hose handling assembly can be configured with a height of approximately 4 feet to approximately 6 feet (although other greater or lesser heights also can be provided) such that, before any extension, the hose can be positioned at an elevation of between approximately 3-4 feet to approximately 5-6 feet above the ground. In embodiments, the first, second and third sections (e.g., the base 110, cradle support 131, and the hose cradle 151/200/220) can be of different sizes, with the base typically forming a largest section of the body for support.

In addition, the movement of the hose between its lowered and one or more elevated positions generally can be controlled by controlling the extension of the lifting rods 122 of the lifting mechanisms 120 of the base 110, by the extension of the lifting rod 136 of the lifting mechanism 135 of the cradle support 131, or by a combination of the operations of both lifting mechanisms 120 and 135. Once a hose has been positioned and/or secured within the hose cradle, the hose can be moved in a substantially vertical direction (in the direction of arrows 125A/125B) so as to move the hose from an initial, lowered position, approximately 2 feet to approximately 8 feet as needed to locate the hose in a selected or desired elevated position spaced above the ground. For example, as shown in FIGS. 8A-8B, in instances where the outlet of a pumping unit is at an elevated position (e.g., up to about 8 feet above ground level), the hose can be raised approximately 2-6 feet as needed to substantially align an end of the hose with the outlet of the pumping unit. In other situations, the hose cradle, with the hose received therein, may need to be moved to an even higher elevation, such as where the terrain slopes.

Still further, in embodiments, the hose cradle, with the hose received therein, also can be pivoted. For example, the hose cradle, with a hose positioned therein, pivot in response to the substantially vertical movement of the hose cradle by the lifting mechanism(s), which can cause the hose to be oriented in a sloping alignment toward the manifold assembly, as opposed to having the hose being bent and lying flat along the ground surface.

In addition, once the hose has been located at a selected elevated position, or, in some embodiments, prior to elevating the hose, the hose can be rotated or turned as needed to align the hose for connection to a coupling or an outlet of the pumping unit or and inlet of the manifold assembly. For example, as indicated in FIGS. 4E, 5A-5B and 6A-6D, the body of a hose can be engaged and secured by a drive mechanism within the hose cradle 151 (e.g., being engaged between opposed drive wheels 162A/162B as shown in FIG. 4E, being engaged on or between one or more drive belts 191 as shown in FIGS. 5A-5B, or by being engaged by a clamp mechanism 200 as shown in FIGS. 6A-6D) to hold the hose in place along a substantially horizontal plane. Thereafter, the hose cradle or clamping mechanism can be rotated or turned in the direction of arrows 140A/140B about the vertical axis Y to orient or align the hose with the outlet 41A (FIGS. 8A-8B) of the pump 41 or the inlet 32 of the manifold assembly 23.

Thus, the hose handling assemblies of the present disclosure are configured to support one or more hoses used for conveying fluids such as, for example, pressurized fracturing fluids used in hydraulic fracturing operations in various positions, including, one or more elevated positions above a ground surface and away from contact with potentially at a hydraulic fracturing site so that the one or more hoses can be kept of substantial contact, dirt, debris and corrosive or other contaminant materials on the ground. The hose handling assemblies additionally can facilitate the manipulation and movement of the hose(s) in multiple directions (e.g., movement in a substantially vertical direction, turning or rotational movement, movement along a substantially horizontal plane, and/or a pivoting movement). Thus, the hose(s) can be positioned as needed, (e.g. to align the hoses to be positioned in a substantially straight line or linear arrangement between one or more pumping units and an inlet or outlet of a manifold, such a manifold monobore, of a hydraulic fracturing system, which enables a substantially straight flow path for the pressurized fluids to be created through the hose(s), substantially minimizing restrictions of a flow of such fluids through the one or more hoses), and without requiring the use heavy equipment such as a crane.

This application claims priority to and the benefit of U.S. Provisional Application No. 63/713,879, filed Oct. 30, 2024, titled “HYDRAULIC FRACTURING HOSE HANDLING ASSEMBLY AND METHODS OF USE,” and U.S. Provisional Application No. 63/717,584, filed Nov. 7, 2024, titled “HYDRAULIC FRACTURING HOSE HANDLING ASSEMBLY AND METHODS OF USE,” the disclosures of which are incorporated herein by reference in their entireties.

The present disclosure has been described herein in terms of examples that illustrate principles and aspects of the present disclosure. The skilled artisan will understand, however, that the embodiments described herein are exemplary only and are not limiting, and that a wide gamut of additions, deletions, alterations, and modifications, both subtle and gross, may be made to the presented examples without departing from the spirit and scope of the present disclosure. All such modifications which do not depart from the spirit of the disclosure are intended to be included within the scope of any of the aspects and/or claims provided by the present disclosure.

1. A system for supplying fluid to a manifold assembly for hydraulic fracturing operations, the system comprising:
one or more pumping units coupled to a fluid supply and configured to pump a pressurized fluid from the fluid supply to one or more inlets located along a fluid delivery conduit of the manifold assembly and configured to introduce the pressurized fluid into the fluid delivery conduit;
one or more hoses having a first end coupled to the one or more pumping units and a second end coupled to the one or more inlets, the one or more hoses configured to deliver the pressurized fluid from the one or more pumping units along a flow path to the one or more inlets;
a hose handling assembly positioned along a length of the one or more hoses, configured to support the one or more hoses in an elevated position, and configured to move one or more hoses in multiple directions.

2. The system of claim 1, wherein the hose handling assembly comprises:
a body including:
a base,
a cradle support having a first end connected to the base and a second end,
a hose cradle coupled to the second end of the cradle support and having a channel defined therethrough and along which at least a portion of the one or more hoses is received, and
one or more lifting mechanisms attached to the hose cradle, to the base, or to the cradle support, and configured to move the hose cradle, the base, or the cradle support in a substantially vertical direction for moving the one or more hoses from a lowered position to the elevated position.

3. The system of claim 2, wherein the hose handling assembly further comprises a injector drive mechanism positioned along the hose cradle, the injector drive mechanism including one or more drive wheels positioned along the channel defined through the hose cradle and adapts to engage the one or more hoses, and one or more motors coupled to the one or more drive wheels, and wherein the one or more motors is configured to selectively drive rotation of the one or more drive wheels for moving the one or more hoses in a horizontal direction.

4. The system of claim 2, wherein the hose cradle is rotatably coupled to the second end of the cradle support so as to enable rotation of the one or more hoses about a substantially vertically extending axis to reorient the flow path defined through the one or more hose, wherein the one or more lifting mechanisms comprises an actuator positioned along the cradle support, and a lifting rod connected to the actuator and to the hose cradle, and wherein the actuator is operable to selectively extend or retract the lifting rod for moving the one or more hoses between lowered position and one or more elevated positions.

5. The system of claim 1, wherein the hose handling assembly comprises a body including a base and a hose cradle rotatably coupled to the base,
wherein the hose cradle includes channel defined therethrough and along which the one or more hoses is received, and a drive mechanism,
wherein the drive mechanism includes one or more drive wheel arranged along the channel of the hose cradle in a position to engage the one or more hose, and a motor configured to drive rotation of the one or more drive wheel, and
wherein as the one or more drive wheel is driven by the motor, engage the one or more drive wheel moves the one or more hoses in a substantially horizontal direction.

6. The system of claim 1, wherein the hose handling assembly comprises:
a body including:
a base,
a cradle support mounted to the base, and
a hose cradle rotatably mounted to the cradle support, configured to receive the one or more hoses therethrough, and rotatably coupled to the cradle support so as to enable the hose to be selectively turned about a substantially vertically extending axis,
an injector drive mechanism configured to move the one or more hoses through the hose cradle in a substantially horizontal direction, and
one or more lifting mechanisms mounted along the body and configured to move the hose cradle in a substantially vertical direction.

7. The system of claim 1, wherein the hose handling assembly is configured to facilitate a turning movement of the one or more hose, a pivoting movement of the one or more hose, movement of the one or more hoses in a substantially vertical direction, and movement of the one or more hoses in a substantially horizontal direction.

8. A hose handling assembly for a hydraulic fracturing system, comprising:
a body,
a hose cradle positioned along the body and configured to receive a hose of the hydraulic fracturing system therethrough,
one or more lifting mechanisms mounted along the body and configured to move at least a portion of the body, the hose cradle, or a combination thereof, in a substantially vertical direction,
an injector drive mechanism configured to engage and move the hose in a substantially horizontal direction, and
wherein the hose cradle is rotatably coupled to the body to enable the hose to be turned about a substantially vertically extending axis extending through the body.

9. The hose handling assembly of claim 8, further comprising a pivoting connector positioned at an upper end of a lifting rod of the one or more lifting mechanisms and pivotally coupled to the hose cradle, and wherein the pivoting connector is configured to enable pivoting of the hose and turning of the hose.

10. The hose handling assembly of claim 8, wherein the one or more lifting mechanisms comprises an actuator, a lifting rod engaged by the actuator and coupled the hose cradle, and wherein the actuator is operable to selectively extend or retract the lifting rod for moving the hose cradle in the substantially vertical direction to move the hose between a lowered position and one or more elevated positions.

11. The hose handling assembly of claim 8, wherein the actuator of the one or more lifting mechanisms comprises a pneumatic or hydraulic cylinder, a motor, or a manually operable jack mechanism.

12. The hose handling assembly of claim 8, wherein the body comprises a base adapted to engage a ground surface, and a cradle support mounted to the base at a first end and rotatably coupled to the cradle support adjacent a second end thereof.

13. The hose handling assembly of claim 8, wherein the body further includes a base and a cradle support positioned between the base and the hose cradle, wherein the one or more lifting mechanisms is positioned along the cradle support and includes a lifting rod having a connector at a distal end thereof and connected to the hose cradle, and wherein the connector is configured to enable rotation of the hose about a substantially vertically extending axis and pivoting of the hose.

14. The hose handling assembly of claim 8, wherein injector drive mechanism comprises one or more drive wheels positioned along a channel defined through the hose cradle and adapted to engage the hose, and one or more motors coupled to the one or more drive wheels, and wherein the one or more motors is configured to selectively drive rotation of the one or more drive wheels for moving the hose in the substantially horizontal direction.

15. The hose handling assembly of claim 8, wherein the injector drive mechanism comprises one or more drive belt positioned within a channel defined though the hose cradle, and one or more motors coupled to the one or more drive belt and operable to drive the one or more drive belt in the substantially horizontal direction.

16. The hose handling assembly of claim 8, wherein the injector drive mechanism is positioned at a location spaced from the body, and wherein the injector drive mechanism comprises a pair of drive belts defining a passage along which the hose is received and one or more actuators connected to the drive belts and operable to drive the drive belts in forward and reverse directions for moving the hose in the substantially horizontal direction.

17. A fluid delivery system for a hydraulic fracturing operation, comprising:
one or more pumping units coupled to a fluid supply and configured to pump a pressurized fluid from the fluid supply to a fluid delivery conduit of a manifold assembly,
one or more hoses coupled to the one or more pumping units at a first end and to an inlet of the fluid delivery conduit at a second end, the at least one hose configured to deliver the pressurized fluid from the one or more pumping units along a flow path to the inlet, and
one or more hose handling assemblies positionable between one or more pumping units and the fluid delivery conduit, the one or more hose handling assemblies is configured to support the one or more hoses in an elevated position and to facilitate movement of the one or more hoses in multiple directions.

18. The system of claim 17, wherein the hose handling assembly is configured to facilitate a turning movement of the one or more hoses, a pivoting movement of the one or more hoses, movement of the one or more hoses in a substantially vertical direction, movement of the one or more hoses in a substantially horizontal direction.

19. The system of claim 17, wherein the hose handling assembly comprises a hose cradle configured to receive the one or more hoses therethrough and including an injector drive mechanism operable to move the one or more hoses in a substantially horizontal direction, and wherein the hose cradle is rotatable about a vertical axis to enable turning of the one or more hoses, and wherein the hose handling assembly further comprises a body including a cradle support, a hose cradle rotatably coupled to the cradle support, and one or more lifting mechanisms positioned along the body and configured to move the cradle support or the hose cradle with the one or more hoses supported therein in a substantially vertical direction.

20. The system of claim 18, wherein the one or more lifting mechanisms is positioned along the cradle support at the second end thereof and includes a lifting rod having a rotatable connector at a distal end thereof and connected to the hose cradle.

21. The system of claim 20, further comprising a pivoting connector positioned at an upper end of the lifting rod of the one or more lifting mechanisms and pivotally coupled to the hose cradle; wherein the pivoting connector is configured to enable pivoting of the one or more hoses and turning of the one or more hoses with respect to the cradle support.

22. The system of claim 17, wherein the one or more hose handling assembly comprises:
a body including a base, a cradle support, and a hose cradle coupled to the cradle support and comprising a cradle body configured to receive the one or more hoses therethrough; and
one or more lifting assembly mounted along the body and configured to move the base, the cradle support, or the hose cradle in a substantially vertical direction to raise the one or more hoses to an elevated position;
wherein the hose cradle is rotatably coupled to the cradle support so as to facilitate turning of the one or more hoses about a substantially vertically extending axis; and
wherein the hose cradle is pivotally coupled to the cradle support to facilitate pivoting of the one or more hose, and
the system further comprising an injector drive mechanism linked to the cradle body and configured to move the one or more hoses through the hose cradle in a substantially horizontal direction.

23. The system of claim 22, wherein the injector drive mechanism comprises one or more drive wheels positioned along a channel defined through the hose cradle and adapted to engage the one or more hose, and one or more motor coupled to the one or more drive wheels; and
wherein the one or more motor is configured to selectively drive rotation of the one or more drive wheels for moving the one or more hoses in the substantially horizontal direction.

24. The system of claim 22, wherein the injector drive mechanism is positioned at a location spaced from the body, and wherein the injector drive mechanism comprises a pair of drive belts defining a passage along which the hose is received, and one or more actuator connected to the drive belts and configured to drive the drive belts in forward and reverse directions for moving the hose in the substantially horizontal direction.

25. The system of claim 21, wherein the one or more lifting mechanisms comprises an actuator coupled to a lifting rod extending between the actuator and the hose cradle; and wherein the actuator is operable to selectively extend or retract the lifting rod and move the hose cradle in a vertical direction for moving the one or more hoses between a lowered position and one or more elevated positions.

26. The system of claim 21, wherein the one or more lifting mechanisms comprises a lifting rod and an actuator configured to move the lifting rod in the substantially vertical direction; and wherein the actuator comprises a manually operable jack mechanism, a pneumatic or hydraulic cylinder, or a motor.

27. A method for positioning a hose at a hydraulic fracturing site, the method comprising:
positioning a hose handling assembly between a pumping unit and a manifold assembly;
coupling the hose to the pumping unit;
positioning the hose within a hose cradle of the hose handling assembly;
moving the hose in a substantially vertical direction to an elevated position;
moving the hose in a substantially horizontal direction;
turning the hose about a substantially vertically extending axis; and
pivoting the hose with respect to the pumping unit.

28. The method of claim 27, wherein the hose cradle comprises a clamping mechanism, and wherein positioning the hose within the hose cradle comprises engaging the hose with the clamping mechanism so as to substantially fix the hose against movement in the substantially horizontal direction.

29. The method of claim 27, wherein moving the hose in the substantially horizontal direction comprises selectively engaging the hose with an injector drive mechanism and urging the hose in a forward direction or a reverse direction.

30. The method of claim 27, wherein the hose is caused to move in the substantially horizontal direction by movement of the hose in the substantially vertical direction, and the method further comprising coupling one or more additional hose to the hose to complete a fluid flow path between the pumping unit and the manifold assembly.
